(19) United States
(12) Patent Application Publication
(10) Pub. No.: US 2024/0163459 A1
(43) Pub. Date: May 16, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 18/412,301

(22) Filed: Jan. 12, 2024

Related U.S. Application Data
(63) Continuation of application No. PCT/CN2022/105008, filed on Jul. 11, 2022.

(30) Foreign Application Priority Data
Jul. 15, 2021 (WO) PCT/CN2021/106605

(51) Int. Cl. H04N 19/176; H04N 19/159

(52) U.S. Cl. CPC H04N 19/176; H04N 19/159

(57) ABSTRACT

Embodiments of the present disclosure provide a solution for video processing. A method for video processing is proposed. The method comprises: determining, during a conversion between a target block of a video and a bitstream of the target block, storing information about coding information of a first part of the target block, the target block being coded with a geometric partitioning mode (GPM); and performing the conversion based on the storing information.

### CROSS-REFERENCE TO RELATED APPLICATIONS

This application is a continuation of International Application No. PCT/CN2022/105008, filed on Jul. 11, 2022, which claims the benefit of International Application No. PCT/CN2021/106605 filed on Jul. 15, 2021. The entire contents of these applications are hereby incorporated by reference in their entireties.

### FIELD

Embodiments of the present disclosure relates generally to video coding techniques, and more particularly, to signaling of multiple hypothesis prediction in image/video coding.

### BACKGROUND

In nowadays, digital video capabilities are being applied in various aspects of people's′ lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally low, which is undesirable.

### SUMMARY

Embodiments of the present disclosure provide a solution for video processing.

In a first aspect, a method for video processing is proposed. The method comprises: determining, during a conversion between a target block of a video and a bitstream of the target block, storing information about coding information of a first part of the target block, the target block being coded with a geometric partitioning mode (GPM); and performing the conversion based on the storing information. Compared with the conventional solution, the proposed method can advantageously improve the coding efficiency and performance.

In a second aspect, another method for video processing is proposed. The method comprises: generating, during a conversion between a target block of a video and a bitstream of the target block, a multiple hypothesis prediction block of the target block based on a plurality of intra predictions; and performing the conversion based on the multiple hypothesis prediction block. Compared with the conventional solution, the proposed method can advantageously improve the coding efficiency and performance.

In a third aspect, another method for video processing is proposed. The method comprises: determining, during a conversion between a target block of a video and a bitstream of the target block, whether a coding unit (CU) based geometric partitioning mode (GPM) template matching syntax element is indicated based on whether an intra-inter coding is applied to the target block, the target blocking being a GPM block; and performing the conversion based on the determining Compared with the conventional solution, the proposed method can advantageously improve the coding efficiency and performance.

In a fourth aspect, another method for video processing is proposed. The method comprises: determining, during a conversion between a target block of a video and a bitstream of the target block, for a coding method, a shape of a template used for the target block based on an availability of a neighboring sample associated with the target block; and performing the conversion based on the determining Compared with the conventional solution, the proposed method can advantageously improve the coding efficiency and performance.

In a fifth aspect, an apparatus for processing video data is proposed. The apparatus for processing video data comprising a processor and a non-transitory memory with instructions thereon, wherein the instructions upon execution by the processor, cause the processor to perform a method in accordance with any of the first, second, third or fourth aspect.

In a sixth aspect, an apparatus for processing video data is proposed. The non-transitory computer-readable storage medium storing instructions that cause a processor to perform a method in accordance with any of the first, second, third or fourth aspect.

In a seventh aspect, a non-transitory computer-readable recording medium is proposed. The non-transitory computer-readable recording medium storing a bitstream of a video which is generated by a method performed by a video processing apparatus, wherein the method comprises: determining storing information about coding information of a first part of a target block, the target block being coded with a geometric partitioning mode (GPM); and generating a bitstream of the target block based on the storing information.

In an eighth aspect, another method for storing bitstream of a video is proposed. The method comprises: determining storing information about coding information of a first part of a target block, the target block being coded with a geometric partitioning mode (GPM); generating a bitstream of the target block based on the storing information; and storing the bitstream in a non-transitory computer-readable recording medium.

In a ninth aspect, another non-transitory computer-readable recording medium is proposed. The non-transitory computer-readable recording medium stores a bitstream of a video which is generated by a method performed by a video processing apparatus, wherein the method comprises: generating a multiple hypothesis prediction block of a target block based on a plurality of intra predictions; and generating a bitstream of the target block based on the multiple hypothesis prediction block.

In a tenth aspect, another method for storing bitstream of a video is proposed. The method comprises generating a multiple hypothesis prediction block of a target block based on a plurality of intra predictions; generating a bitstream of the target block based on the multiple hypothesis prediction block; and storing the bitstream in a non-transitory computer-readable recording medium.

In an eleventh aspect, another non-transitory computer-readable recording medium is proposed. The non-transitory computer-readable recording medium stores a bitstream of a video which is generated by a method performed by a video processing apparatus, wherein the method comprises: determining whether a coding unit (CU) based geometric partitioning mode (GPM) template matching syntax element is indicated based on whether an intra-inter coding is applied to a target block, the target blocking being a GPM block; and generating a bitstream of the target block based on the determining.

In a twelfth aspect, another method for storing bitstream of a video is proposed. The method comprises: determining whether a coding unit (CU) based geometric partitioning mode (GPM) template matching syntax element is indicated based on whether an intra-inter coding is applied to a target block, the target blocking being a GPM block; generating a bitstream of the target block based on the determining; and storing the bitstream in a non-transitory computer-readable recording medium.

In a thirteenth aspect, another non-transitory computer-readable recording medium is proposed. The non-transitory computer-readable recording medium stores a bitstream of a video which is generated by a method performed by a video processing apparatus, wherein the method comprises: determining, for a coding method, a shape of a template used for a target block based on an availability of a neighboring sample associated with the target block; and generating a bitstream of the target block based on the determining.

In a fourteenth aspect, another method for storing bitstream of a video is proposed. The method comprises: determining, for a coding method, a shape of a template used for a target block based on an availability of a neighboring sample associated with the target block; generating a bitstream of the target block based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is a schematic diagram of intra prediction modes;

FIG. 5 illustrates a block diagram of reference samples for wide-angular intra prediction;

FIG. 6 illustrates a schematic diagram of problem of discontinuity in case of directions beyond 45′;

FIG. 7 illustrates a schematic diagram of definition of samples used by PDPC applied to diagonal and adjacent angular intra modes;

FIG. 8 illustrates a schematic diagram of example of four reference lines neighboring to a prediction block;

FIG. 9 illustrates a schematic diagram of sub-partition depending on the block size;

FIG. 10 illustrates matrix weighted intra prediction process;

FIG. 11 illustrates positions of spatial merge candidate;

FIG. 12 illustrates candidate pairs considered for redundancy check of spatial merge candidates;

FIG. 13 illustrates an illustration of motion vector scaling for temporal merge candidate;

FIG. 14 illustrates candidate positions for temporal merge candidate, C0 and C1;

FIG. 15 illustrates a schematic diagram of MMVD search point;

FIG. 16 illustrates extended CU region used in BDOF;

FIG. 17 illustrates an illustration for symmetrical MVD mode;

FIG. 18 illustrates decoding side motion vector refinement;

FIG. 19 illustrates top and left neighboring blocks used in CIIP weight derivation;

FIG. 20 illustrates examples of the GPM splits grouped by identical angles;

FIG. 21 illustrates uni-prediction MV selection for geometric partitioning mode;

FIG. 22 illustrates exemplified generation of a bending weight w0 using geometric partitioning mode;

FIG. 23 illustrates a proposed intra block decoding process;

FIG. 24 illustrates a HoG computation from a template of width of 3 pixels;

FIG. 25 illustrates a prediction fusion by weighted averaging of two HoG modes and planar;

FIG. 26 illustrates a flow chart of a method according to embodiments of the present disclosure;

FIG. 27 illustrates a flow chart of a method according to embodiments of the present disclosure;

FIG. 28 illustrates a flow chart of a method according to embodiments of the present disclosure;

FIG. 29 illustrates a flow chart of a method according to embodiments of the present disclosure; and

FIG. 30 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

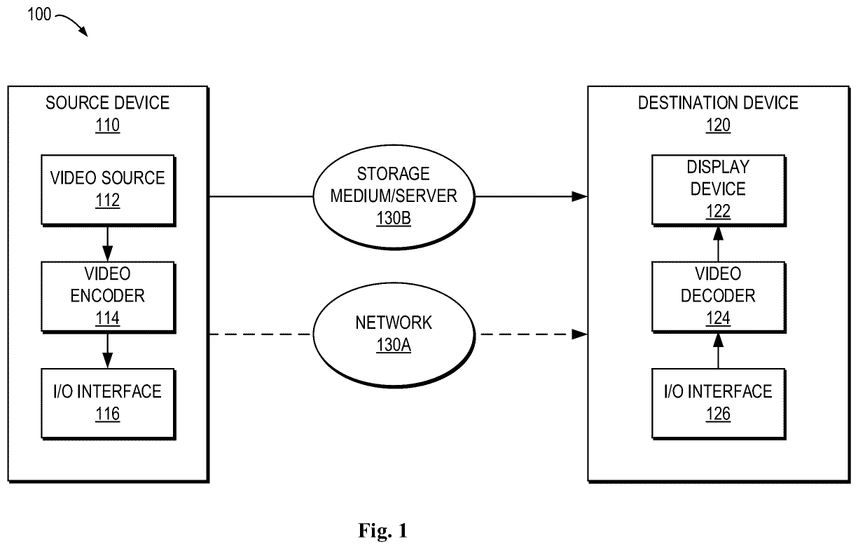

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

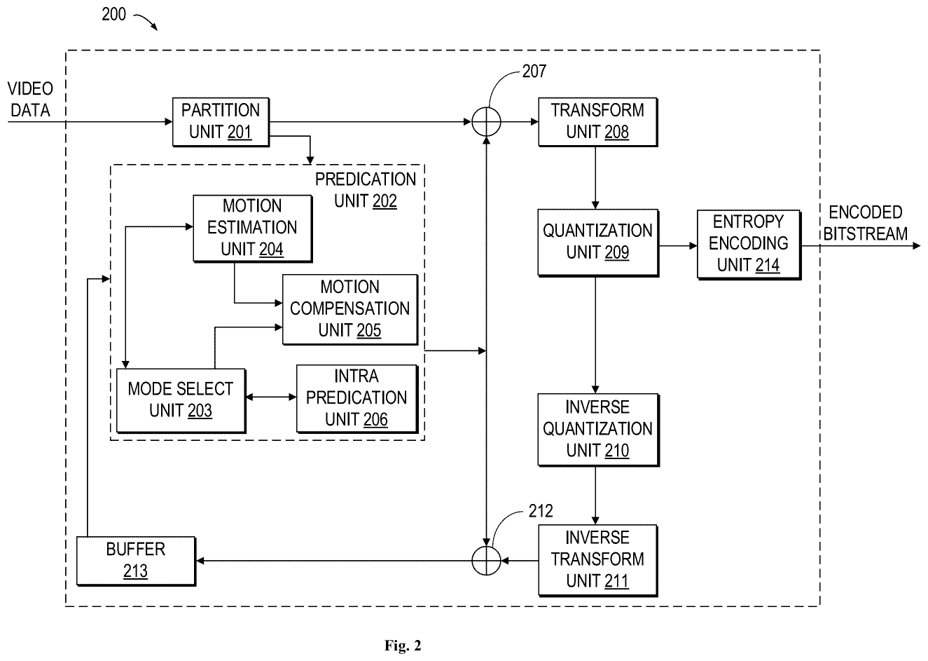

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

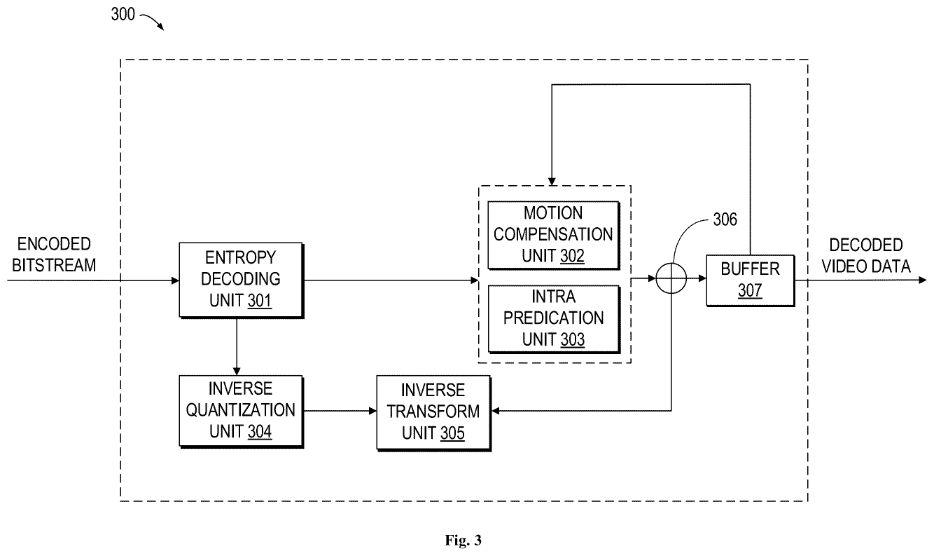

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

The present disclosure is related to video coding technologies. Specifically, it is about generating prediction blocks from more than one composition, wherein each composition may be obtained from different coding techniques. It may be applied to the existing video coding standard like HEVC, VVC, and etc. It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

2.1. Coding Tools

2.1.1. Intra Prediction

2.1.1.1. Intra Mode Coding with 67 Intra Prediction Modes

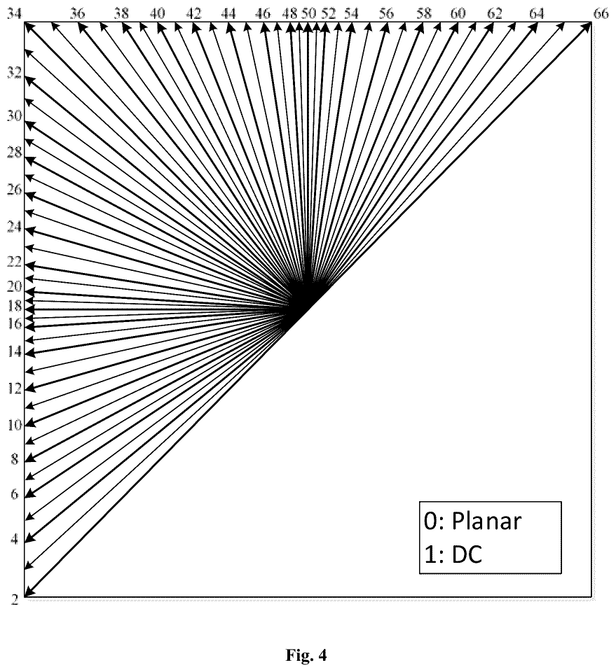

To capture the arbitrary edge directions presented in natural video, the number of directional intra modes in VVC is extended from 33, as used in HEVC, to 65. The new directional modes not in HEVC are depicted as red dotted arrows in FIG. 4, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

2.1.1.2. Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, DC, Max−1, Max+1, Max−2}
If Left and Above are both angular and they are different:
   Set a mode Max as the larger mode in Left and Above
   if the difference of mode Left and Above is in the range of 2 to 62, inclusive
      MPM list→{Planar, Left, Above, DC, Max−1, Max+1}
   Otherwise
      MPM list→{Planar, Left, Above, DC, Max−2, Max+2}
If Left and Above are both angular and they are the same:
   MPM list→{Planar, Left, Left−1, Left+1, DC, Left−2}

Besides, the first bin of the mpm index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

2.1.1.3. Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

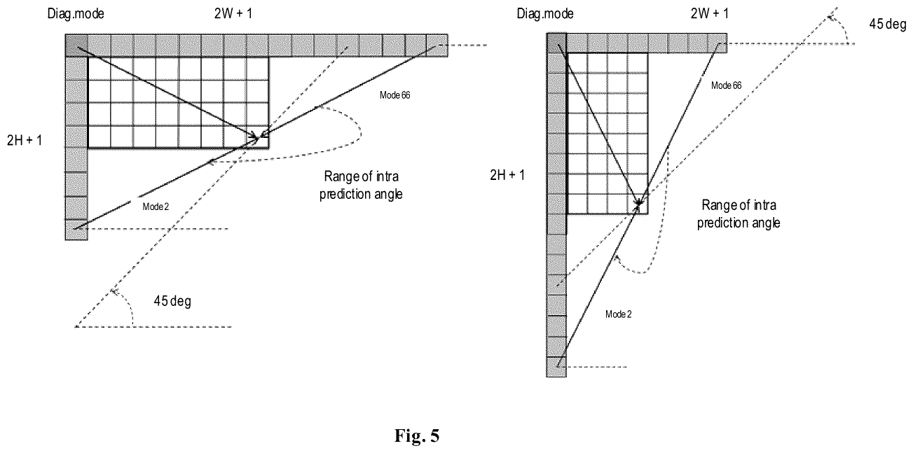

To support these prediction directions, the top reference with length 2W+1, and the left reference with length 2H+1, are defined as shown in FIG. 5.

The number of replaced modes in wide-angular direction mode depends on the aspect ratio of a block. The replaced intra prediction modes are illustrated in Table 1

TABLE 1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, |
| | 8, 9, 10, 11 |
| W/H == 2 | Modes 2, 3, 4, 5, 6, 7, |
| W/H == 1 | None |
| W/H == 1/2 | Modes 61, 62, 63, 64, 65, 66 |
| W/H == 1/4 | Mode 57, 58, 59, 60, 61, 62, |
| | 63, 64, 65, 66 |
| W/H == 1/8 | Modes 55, 56 |
| W/H == 1/16 | Modes 53, 54, 55, 56 |

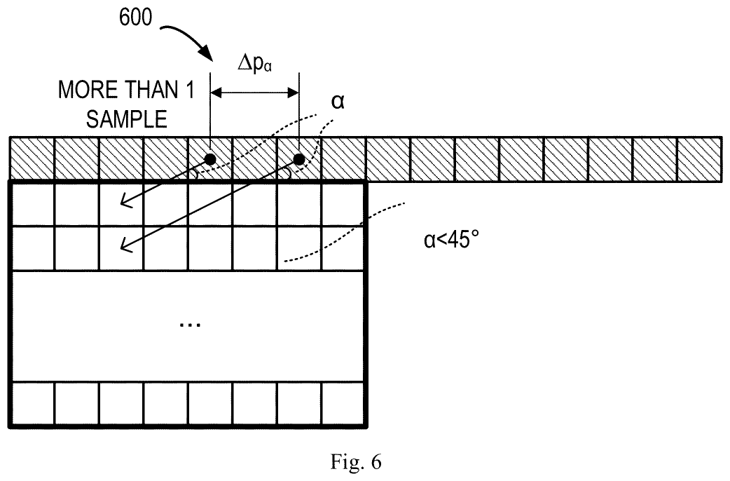

FIG. 6 illustrates a block diagram of discontinuity in case of directions beyond 45 degree. As shown in the diagram 600 of FIG. 6, two vertically adjacent predicted samples may use two non-adjacent reference samples in the case of wide-angle intra prediction Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore chroma DM derivation table for 4:2:2: chroma format is updated by replacing some values of the entries of the mapping table to convert prediction angle more precisely for chroma blocks.

2.1.1.4. Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66.

Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

2.1.1.5. Position Dependent Intra Prediction Combination

In VVC, the results of intra prediction of DC, planar and several angular modes are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signaling: planar, DC, horizontal, vertical, bottom-left angular mode and its eight adjacent angular modes, and top-right angular mode and its eight adjacent angular modes.

The prediction sample pred(x′,y′) is predicted using an intra prediction mode (DC, planar, angular) and a linear combination of reference samples according to the Equation 3-8 as follows:

pred(x′,y′)=(wL×R_{-1,y′}+wT×R_{x′,-1}−wTL×R_{-1,-1}+(64−wL−wT+wTL)×pred(x′,y′)+32)>>6 (2-1)

where R_{x,-1}, R_{-1,y} represent the reference samples located at the top and left boundaries of current sample (x, y), respectively, and R_{-1,-1} represents the reference sample located at the top-left corner of the current block.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical and clipping operation is avoided. For angular modes, pdpc scale factor is adjusted such that range check is not needed and condition on angle to enable pdpc is removed (scale>=0 is used). In addition, PDPC weight is based on 32 in all angular mode cases. The PDPC weights are dependent on prediction modes and are shown in Table 2. PDPC is applied to the block with both width and height greater than or equal to 4.

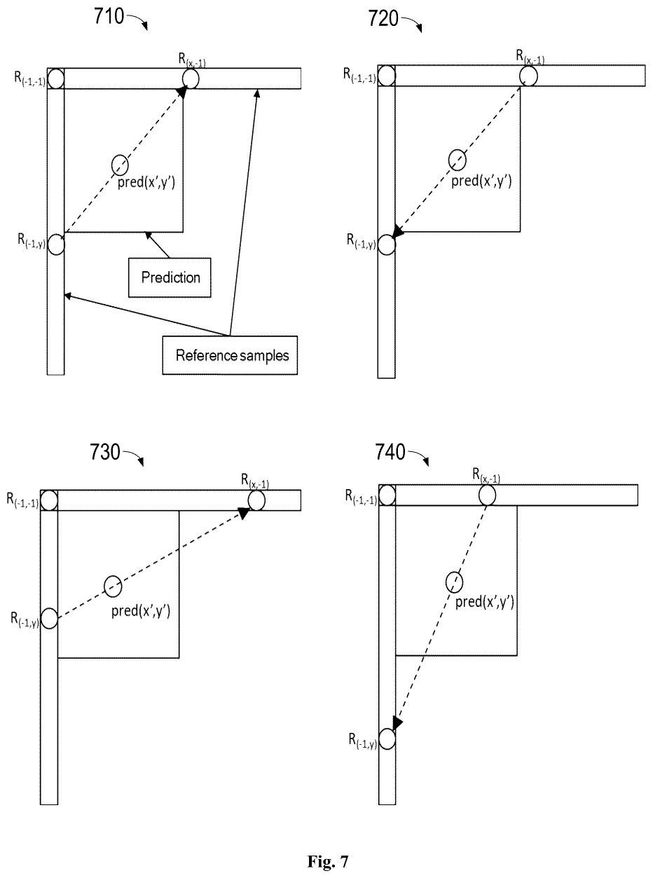

FIG. 7 illustrates the definition of reference samples (R_{x,-1}, R_{-1,y} and R_{-1,-1}) for PDPC applied over various prediction modes. FIG. 7 shows a diagonal top-right mode 710, a diagonal bottom-left mode 720, an adjacent diagonal top-right mode 730 and an adjacent diagonal bottom-left mode 740. The prediction sample pred(x′, y′) is located at (x′, y′)′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other annular mode, the reference samples R_{x,-1} and R_{-1,y} could be located in fractional sample position. In this case, the sample value of the nearest integer sample location is used.

TABLE 2
Example of PDPC weights according to prediction modes

| Prediction modes | wT | wL | wTL |
|---|---|---|---|
| Diagonal | 16 >> ((y′ << 1) >> | 16 >> ((x′ << 1) >> | 0 |
| top-right | shift) | shift) | |
| Diagonal | 16 >> ((y′ << 1) >> | 16 >> ((x′ << 1) >> | 0 |
| bottom-left | shift) | shift) | |
| Adjacent diagonal | 32 >> ((y′ << 1) >> | 0 | 0 |
| top-right | shift) | | |
| Adjacent diagonal | 0 | 32 >> ((x′ << 1) >> | 0 |
| bottom-left | | shift) | |

2.1.1.6. Multiple Reference Line (MRL) Intra Prediction

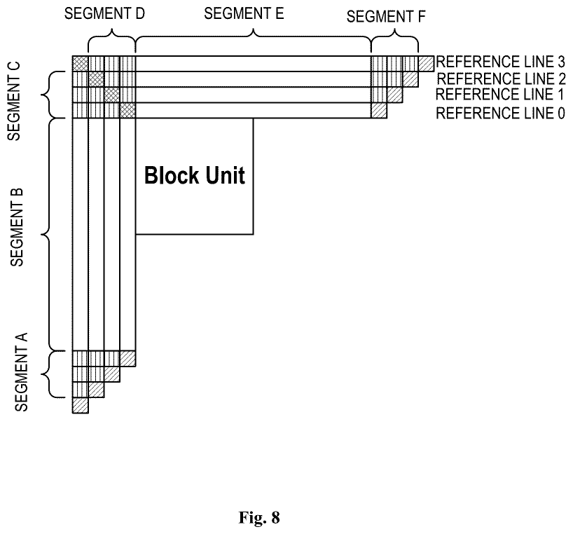

Multiple reference line (MRL) intra prediction uses more reference lines for intra prediction. In FIG. 8, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MLR to use the same 3 lines is aligned as CCLM to reduce the storage requirements for decoders.

2.1.1.7. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

chroma TBs. If the CU uses ISP, then the luma TB will be divided into four M×32 TB s (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIG. 9 shows examples of the two possibilities. All sub-partitions fulfill the condition of having at least 16 samples. FIG. 9 shows an example 910 of sub-partitions for 4×8 and 8×4 CUs and an example 920 of sub-partitions for CUs other than 4×8, 8×4 and 4×4.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 3
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
MPM usage: the MPM flag will be inferred to be one in a block coded by ISP mode, and the MPM list is modified to exclude the DC mode and to prioritize horizontal intra modes for the ISP horizontal split and vertical intra modes for the vertical one.
Transform size restriction: all ISP transforms with a length larger than 16 points uses the DCT-II.
PDPC: when a CU uses the ISP coding mode, the PDPC filters will not be applied to the resulting sub-partitions.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w=2 or w>32, t_{H}=DCT-II
   If h=2 or h>32, t_{V}=DCT-II
   Otherwise, the transform is selected as in Table 4.

TABLE 4
Transform selection depends on intra mode

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5 , 7 . . . 27, 29 | DCT-II | DST-VII |
| Ang. 38, 40, 42 . . . 64, 66 | | |

In ISP mode, all 67 intra modes are allowed. PDPC is also applied if corresponding width and height is at least 4 samples long. In addition, the condition for intra interpolation filter selection doesn't exist anymore, and Cubic (DCT-IF) filter is always applied for fractional position interpolation in ISP mode.

2.1.1.8. Matrix Weighted Intra Prediction (MIP)

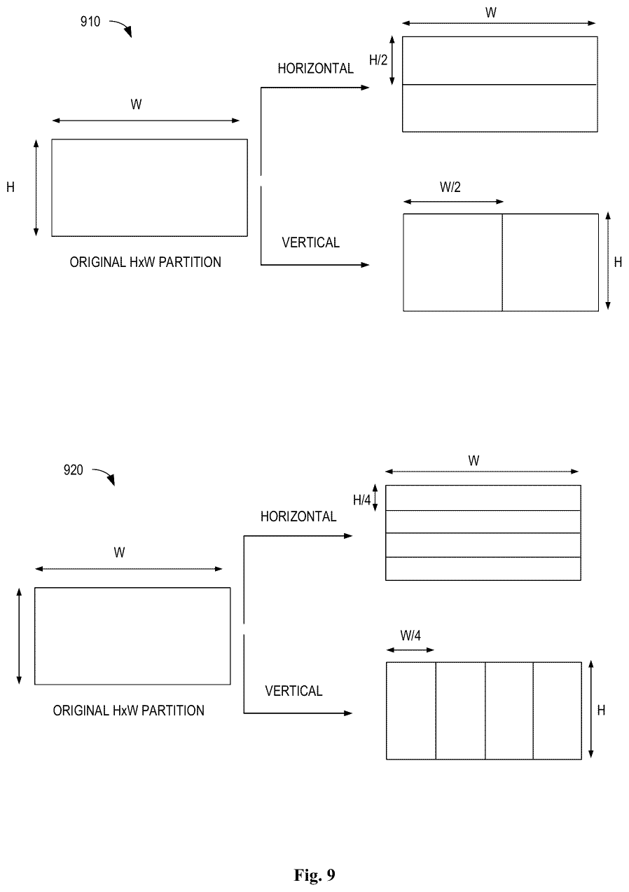

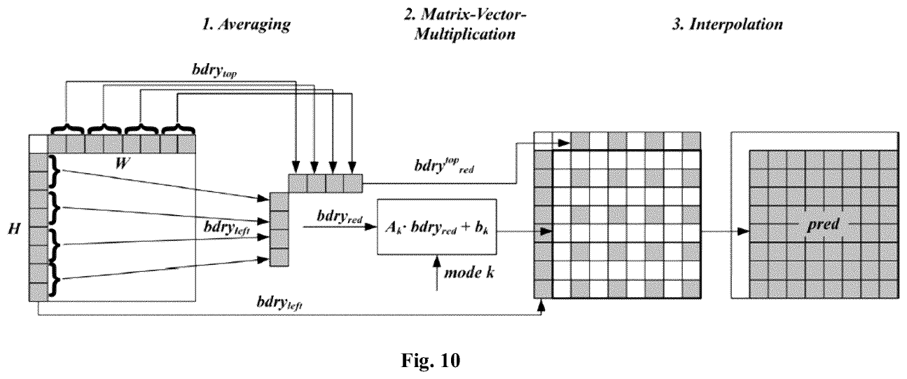

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 10.

3.3.6.1 Averaging Neighboring Samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighboring boundary samples according to predefined rule depends on block size. Then, the two reduced boundaries bdry_{red}^{top} and bdry_{red}^{left} are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 2 )$$

3.3.6.2 Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$$\begin{matrix}{W}_{red} = \{ \begin{matrix}4 & for max ( W , H ) \leq 8 \\ min ( W , 8 ) & for max ( W , H ) > 8\end{matrix} & ( 2 - 3 ) \\ {H}_{red} = \{ \begin{matrix}4 & for max ( W , H ) \leq 8 \\ min ( H , 8 ) & for max ( W , H ) > 8\end{matrix} & ( 2 - 4 )\end{matrix}$$

The reduced prediction signal pred_{red} is computed by calculating a matrix vector product and adding an offset:

pred_{red}=A·bdry_{red}+b.

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8.\end{matrix} \qquad ( 2 - 5 )$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors b₂ⁱ, i∈{0, . . . , 5} of size 64.

3.3.6.3 Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

3.3.6.4 Signaling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signaled. For an MIP mode, a transposed flag (isTransposed), which determines whether the mode is transposed, and MIP mode Id (modeId), which determines which matrix is to be used for the given MIP mode is derived as follows

isTransposed=predModeIntra&1

modeId=predModeIntra>>1 (2-6)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the upsampling step used in the MIP-prediction, original reference samples are used instead of downsampled ones
Clipping is performed before upsampling and not after upsampling
MIP is allowed up to 64×64 regardless of the maximum transform size
The number of MIP modes is 32 for sizeId=0, 16 for sizeId=1 and 12 for sizeId=2

2.1.2. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details on those inter prediction methods specified in VVC.

2.1.2.1. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

2.1.2.2. Spatial Candidates Derivation

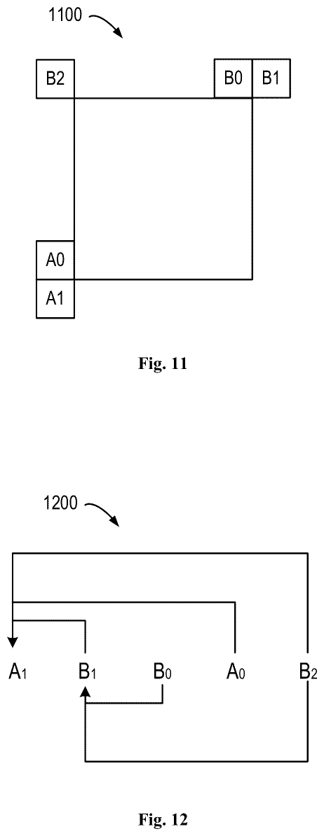

The derivation of spatial merge candidates in VVC is same to that in HEVC except the positions of first two merge candidates are swapped. FIG. 11 is a schematic diagram 1100 illustrating positions of a spatial merge candidate. A maximum of four merge candidates are selected among candidates located in the positions depicted in FIG. 11. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 12 is a schematic diagram 1200 illustrating candidate pairs considered for redundancy check of spatial merge candidates. Instead only the pairs linked with an arrow in FIG. 12 are considered and a candidate is only added to the list if the corresponding candidate used for redundancy check has not the same motion information.

2.1.2.3. Temporal Candidates Derivation

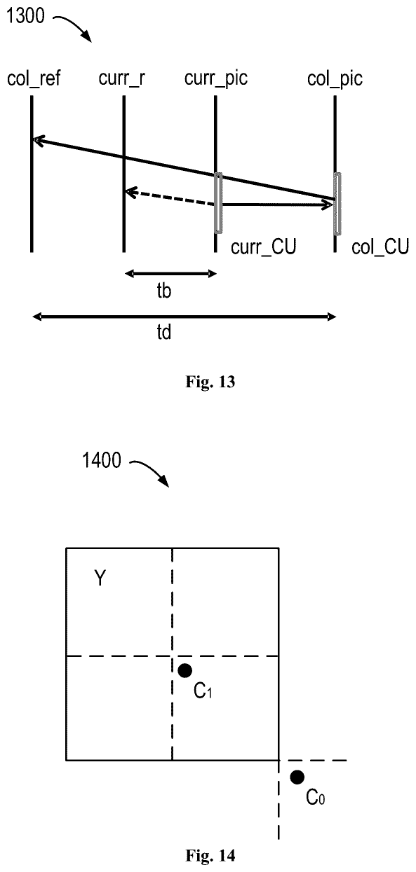

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in the diagram 1300 of FIG. 13, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

FIG. 14 is a schematic diagram 1400 illustrating candidate positions for temporal merge candidate, C₀ and C₁. The position for the temporal candidate is selected between candidates C0 and C1, as depicted in FIG. 14. If CU at position C0 is not available, is intra coded, or is outside of the current row of CTUs, position C1 is used. Otherwise, position C0 is used in the derivation of the temporal merge candidate.

2.1.2.4. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4) ? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

2.1.2.5. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

2.1.2.6. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>>Log 2ParMrgLevel is greater than xCb>>>Log 2ParMrgLevel and (yCb+cbHeight)>>>Log 2ParMrgLevel is great than (yCb>>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.3. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

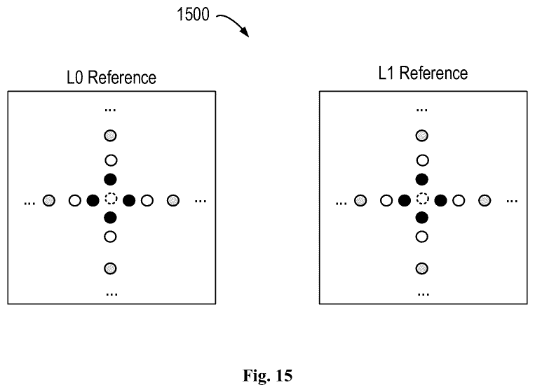

Distance index specifies motion magnitude information and indicate the pre-defined offset from the starting point. FIG. 15 is a schematic diagram 1500 illustrating a merge mode with motion vector differences (MMVD) search point. As shown in FIG. 15, an offset is added to either horizontal component or vertical component of starting MV. The relation of distance index and pre-defined offset is specified in Table 5

TABLE 5
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 6. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 6 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 6 specifies the sign of MV offset added to the list0 MV component of starting MV and the sign for the list1 MV has opposite value.

TABLE 6
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.1.3.1. Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

P_{bi-pred}=((8−w)*P₀+w*P₁+4)>>3 (2-7)

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3, 4, 5}) are used.
At the encoder, fast search algorithms are applied to find the weight index without significantly increasing the encoder complexity. These algorithms are summarized as follows. For further details readers are referred to the VTM software and document WET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

2.1.3.2. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the ATMVP merge mode
CU has more than 64 luma samples
Both CU height and CU width are larger than or equal to 8 luma samples
BCW weight index indicates equal weight
WP is not enabled for the current CU
CIIP mode is not used for the current CU

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) >> shift 1 ) - ( {I}^{( k )} ( i - 1 , j ) >> shift 1 ) ) \qquad ( 2 - 8 )$$

$$\frac{\partial {I}^{( k )}}{\partial y} ( i , j ) = ( ( {I}^{( k )} ( i , j + 1 ) >> shift 1 ) - ( {I}^{( k )} ( i , j - 1 ) >> shift 1 ) )$$

where I^{(k)}(i,j) are the sample value at coordinate (i,j) of the prediction signal in list k, k=0, 1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$$\begin{matrix}{S}_{1} = {Σ}_{( i , j ) ∈ Ω} Abs ( {ψ}_{x} ( i , j ) ) , {S}_{3} = {Σ}_{( i , j ) ∈ Ω} θ ( i , j ) \cdot Sign ( {ψ}_{x} ( i , j ) ) \\ {S}_{2} = {\sum }_{( i , j ) ∈ Ω} {ψ}_{x} ( i , j ) \cdot Sign ( {ψ}_{y} ( i , j ) ) \\ {S}_{5} = {Σ}_{( i , j ) ∈ Ω} Abs ( {ψ}_{y} ( i , j ) ) , {S}_{6} = {Σ}_{( i , j ) ∈ Ω} θ ( i , j ) \cdot Sign ( {ψ}_{y} ( i , j ) ) \\ where & ( 2 - 9 ) \\ {ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a} \\ θ ( i , j ) = ( {I}^{( 1 )} ( i , j ) >> {n}_{b} ) - ( {I}^{( 0 )} ( i , j ) >> {n}_{b} ) & ( 2 - 10 )\end{matrix}$$

where Ω is a 6×6 window around the 4×4 subblock, and the values of nₐ and n_{b} are set equal to min (1, bitDepth−11) and min(4, bitDepth−8), respectively.

The motion refinement (vₓ, v_{y}) is then derived using the cross- and auto-correlation terms using the following:

vₓ=S₁>0?clip3(−th_{BIO}′,th_{BIO}′,−((S₃·2ⁿ^{_{b}}⁻ⁿ^{ₐ})>>└log₂ S┘)):0

v_{y}=S₅>0?clip3(−th_{BIO}′,th_{BIO}′,−((S₆·2ⁿ^{_{b}}⁻ⁿ^{ₐ}−((vₓS_{2,m})<<n_{S}_{₂}+vₓS_{2,s})/2)>>└log₂S₅┘)):0 (2-11)

where

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 12 )$$

└⋅┘ is the floor function, and n_{S}_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 12 )$$

Finally, the BDOF samples of the CU are calculated by adjusting the bi-prediction samples as follows:

pred_{BDOF}(x,y)=(I)⁽⁰⁾(x,y)+I⁽¹⁾(x,y)+b(x,y)+o_{offset})>>shift (2-13)

These values are selected such that the multipliers in the BDOF process do not exceed 15-bit, and the maximum bit-width of the intermediate parameters in the BDOF process is kept within 32-bit.

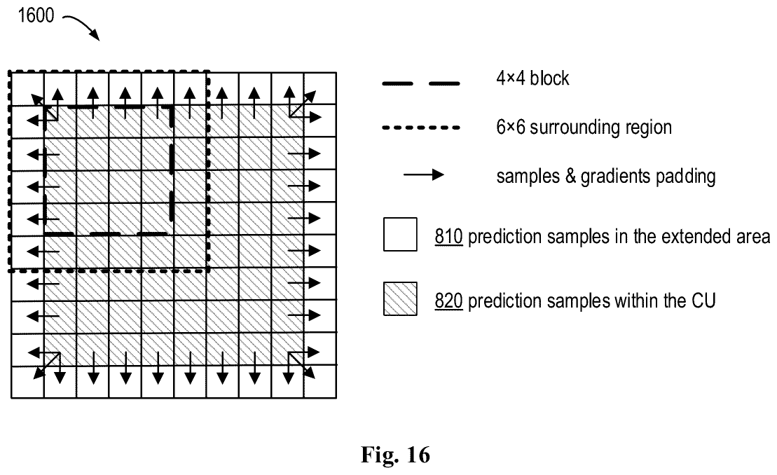

In order to derive the gradient values, some prediction samples I^{(k)}(i,j) in list k (k=0, 1) outside of the current CU boundaries need to be generated. FIG. 16 illustrates a schematic diagram of extended CU region used in BDOF. As depicted in the diagram 1600 of FIG. 16, the BDOF in VVC uses one extended row/column around the CU's boundaries. In order to control the computational complexity of generating the out-of-boundary prediction samples, prediction samples in the extended area (denoted as 1610 in FIG. 16) are generated by taking the reference samples at the nearby integer positions (using floor( ) operation on the coordinates) directly without interpolation, and the normal 8-tap motion compensation interpolation filter is used to generate prediction samples within the CU (denoted as 1620 in FIG. 16). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CLIP mode, BDOF is also disabled.

2.1.4. Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 14 )$$

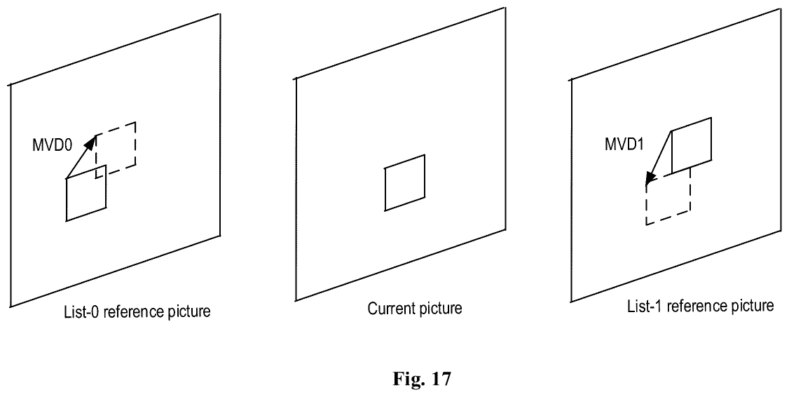

FIG. 17 is an illustration for symmetrical MVD mode. In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

2.1.5. Decoder Side Motion Vector Refinement (DMVR)

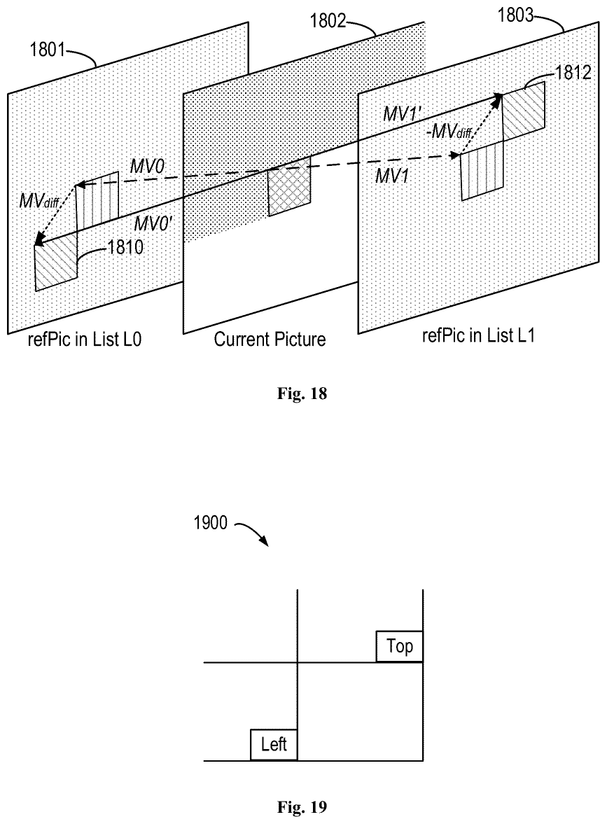

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 18 is a schematic diagram illustrating the decoding side motion vector refinement. As illustrated in FIG. 18, the SAD between the blocks 1810 and 1812 based on each MV candidate around the initial MV is calculated, where the block 1810 is in a reference picture 1801 in the list L0 and the block 1812 is in a reference picture 1803 in the List L1 for the current picture 1802. The MV candidate with the lowest SAD becomes the refined MV and used to generate the bi-predicted signal.

In VVC, the DMVR can be applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding. The additional features of DMVR are mentioned in the following sub-clauses.

2.1.5.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

MV0′=MV0+MV_offset (2-15)

MV1′=MV1−MV_offset (2-16)

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

E(x,y)=A(x−xₘᵢₙ)²+B(y−yₘᵢₙ)²+C (2-17)

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

xₘᵢₙ=(E(−1,0)−E(1,0))/(2(E(−1,0)+E(1,0)−2E(0,0))) (2-18)

yₘᵢₙ=(E(0,−1)−E(0,1))/(2((E(0,−1)+E(0,1)−2E(0,0))) (2-19)

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

2.1.5.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

2.1.5.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

2.1.6. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in a schematic diagram 1900 in FIG. 19) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

P_{CIIP}=((4−wt)*Pᵢₙₜₑᵣ+wt*Pᵢₙₜᵣₐ−2)>>2 (2-20)

2.1.7. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

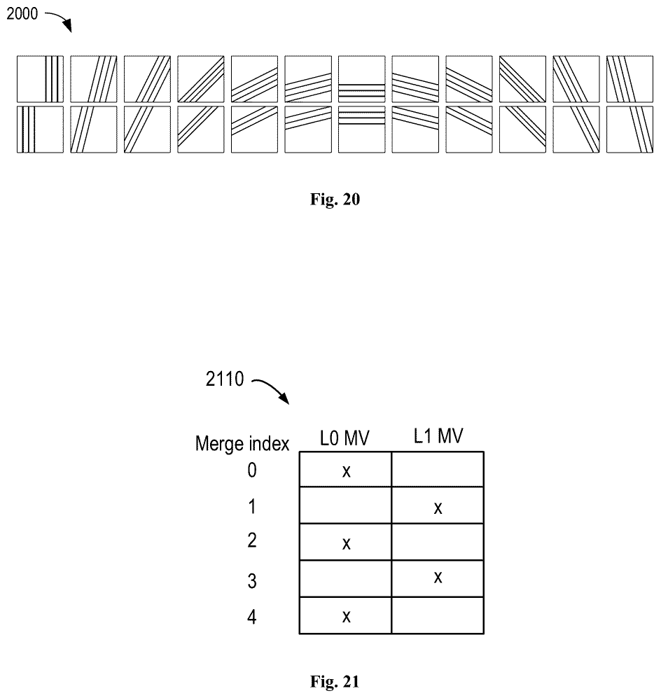

FIG. 20 shows a schematic diagram 2000 of examples of the GPM splits grouped by identical angles. When this mode is used, a CU is split into two parts by a geometrically located straight line (FIG. 20). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

2.1.7.1. Uni-Prediction Candidate List Construction

The uni-prediction candidate list is derived directly from the merge candidate list constructed according to the extended merge prediction process. FIG. 21 is a schematic diagram illustrating the uni-prediction MV selection for geometric partitioning mode. Denote n as the index of the uni-prediction motion in the geometric uni-prediction candidate list 2110. The LX motion vector of the n-th extended merge candidate, with X equal to the parity of n, is used as the n-th uni-prediction motion vector for geometric partitioning mode. These motion vectors are marked with “x” in FIG. 21. In case a corresponding LX motion vector of the n-the extended merge candidate does not exist, the L(1−X) motion vector of the same candidate is used instead as the uni-prediction motion vector for geometric partitioning mode.

2.1.7.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$\begin{matrix}d ( x , y ) = ( 2 x + 1 - w ) cos ( {φ}_{i} ) + ( 2 y + 1 - h ) sin ( {φ}_{i} ) - {ρ}_{j} & ( 2 - 21 ) \\ {ρ}_{j} = {ρ}_{x , j} cos ( {φ}_{i} ) + {ρ}_{y , i} sin ( {φ}_{i} ) & ( 2 - 22 ) \\ {ρ}_{x , j} = \{ \begin{matrix}0 & i \% 16 = 8 or ( i \% 16 \neq 0 and h \geq w ) \\ \pm ( j \times w ) >> 2 & otherwise\end{matrix} & ( 2 - 23 ) \\ {ρ}_{y , j} = \{ \begin{matrix}\pm ( j \times h ) >> 2 & i \% 16 = 8 or ( i \% 16 \neq 0 and h \geq w ) \\ 0 & otherwise\end{matrix} & ( 2 - 24 )\end{matrix}$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$\begin{matrix}wIdxL ( x , y ) = partIdx ? 32 + d ( x , y ) : 32 - d ( x , y ) & ( 2 - 25 ) \\ {w}_{0} ( x , y ) = \frac{Clip 3 ( 0 , 8 , ( wIdxL ( x , y ) + 4 ) >> 3 )}{8} & ( 2 - 26 ) \\ {w}_{1} ( x , y ) = 1 - {w}_{0} ( x , y ) & ( 2 - 27 )\end{matrix}$$

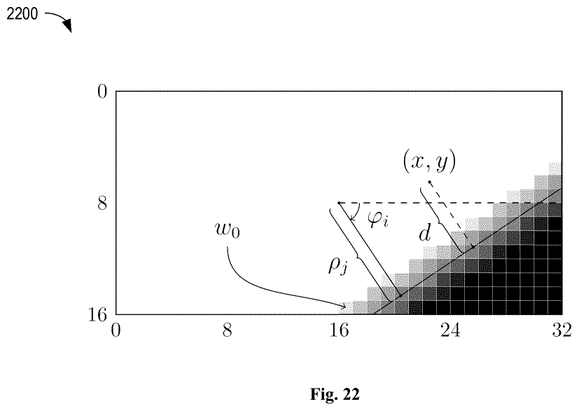

The partIdx depends on the angle index i. One example of weigh w₀ is illustrated in the schematic diagram 2200 of FIG. 22.

2.1.7.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

sType=abs(motionIdx)<32?2:(motionIdx≤0?(1−partIdx):partIdx) (2-43)

where motionIdx is equal to d (4×+2, 4y+2), which is recalculated from equation (2-36). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

2.1.8. Multi-Hypothesis Prediction (MHP)

The multi-hypothesis prediction previously proposed in JVET-M0425 is adopted in this contribution. Up to two additional predictors are signalled on top of inter AMVP mode, regular merge mode, and MMVD mode. The resulting overall prediction signal is accumulated iteratively with each additional prediction signal.

pₙ₊₁=(1−αₙ₊₁)pₙ+αₙ₊₁hₙ₊₁

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

2.1.9. Decoder Side Intra Mode Derivation (DIMD)

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e. throughput of 4×4 blocks). The following sections describe the modifications for each aspect.

2.1.9.1. Signalling

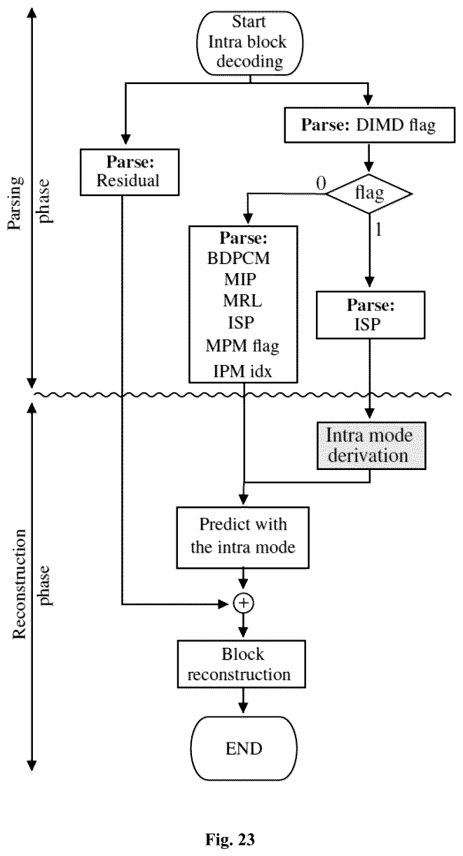

FIG. 23 shows the order of parsing flags/indices in VTM5, integrated with the proposed DIMD. As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR IDX is used as the virtual IPM of the DIMD block.

2.1.9.2. Texture Analysis

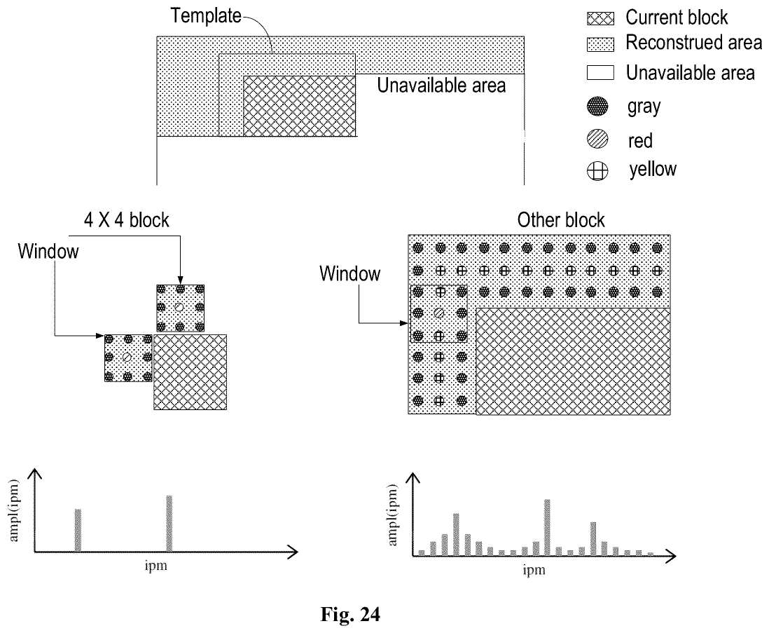

The texture analysis of DIMD includes a Histogram of Gradient (HoG) computation (shown in FIG. 24). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block. In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 24.

In addition to reduction in the number of operations for gradient computation, this property also Simplifies the selection of best 2 modes from the HoG, as the resulting HoG cannot have more than two non-zero amplitudes.

2.1.9.3. Prediction Fusion

This method uses a fusion of three predictors for each block. However, the choice of prediction modes is different and makes use of the combined hypothesis intra-prediction method, where the Planar mode is considered to be used in combination with other modes when computing an intra-predicted candidate. In the current version, the two IPMs corresponding to two tallest HoG bars are combined with the Planar mode.

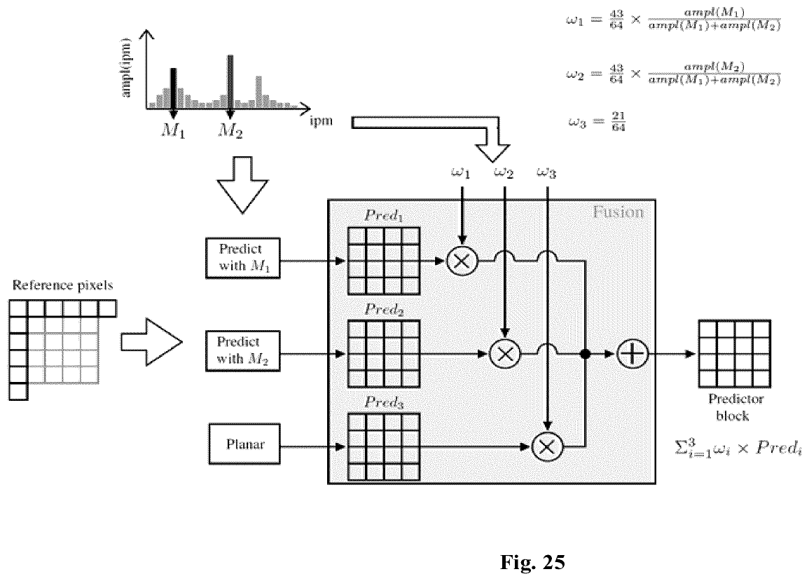

The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 25 visualises this process.

2.1.10. Template-Based Intra Mode Derivation (TIMD)

A TIMD mode is derived from MPMs using the neighbouring template. The TIMD mode is used as an additional intra prediction method for a CU.

2.1.10.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

2.1.10.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

2.1.10.3. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

### 3. Problems

There are several issues in the existing video coding techniques, which would be further improved for higher coding gain.
(1) The combination of multiple hypothesis prediction (e.g., CIIP, MHP, and etc.) with other coding tools need to be carefully designed.
(2) The coding methods for generating compositions for a multiple hypothesis prediction block need to be carefully designed.

### 4. Embodiments of the Present Disclosure

Embodiments of the present disclosure below should be considered as examples to explain general concepts. These inventions should not be interpreted in a narrow way. Furthermore, these inventions can be combined in any manner

The terms ‘video unit’ or ‘coding unit’ or ‘block’ may represent a coding tree block (CTB), a coding tree unit (CTU), a coding block (CB), a CU, a PU, a TU, a PB, a TB.

In this invention, regarding “a block coded with mode N”, here “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, MMVD, BCW, HMVP, SbTMVP, and etc.).

A “multiple hypothesis prediction” in this invention may refer to any coding tool that combining/blending more than one prediction/composition/hypothesis into one for later reconstruction process. For example, a composition/hypothesis may be INTER mode coded, INTRA mode coded, or any other coding mode/method like CIIP, GPM, MHP, and etc.

In the following discussion, a “base hypothesis” of a multiple hypothesis prediction block may refer to a first hypothesis/prediction with a first set of weighting values.

In the following discussion, an “additional hypothesis” of a multiple hypothesis prediction block may refer to a second hypothesis/prediction with a second set of weighting values.

The Compositions of Multiple Hypothesis Prediction
1. In one example, mode X may NOT be allowed to generate a hypothesis of a multiple hypothesis prediction block coded with multiple hypothesis prediction mode Y.
   1) For example, a base hypothesis of a multiple hypothesis prediction block may not be allowed to be coded by mode X.
   2) For example, an additional hypothesis of a multiple hypothesis prediction block may not be allowed to be coded by mode X.
   3) For example, for an X-coded block, it may never signal any block level coding information related to mode Y.
   4) For example, X is a palette coded block (e.g., PLT mode).
   5) Alternatively, mode X may be allowed to be used to generate a hypothesis of a multiple hypothesis prediction block coded with mode Y.
      a) For example, X is a Symmetric MVD coding (e.g., SMVD) mode.
      b) For example, X is based on a template matching based technique.
      c) For example, X is based on a bilateral matching based technique.
      d) For example, X is a combined intra and inter prediction (e.g., CIIP) mode.
      e) For example, X is a geometric partition prediction (e.g., GPM) mode.
   6) Mode Y may be CIIP, GPM or MHP.
2. CIIP may be used together with mode X (such as GPM, or MMVD, or affine) for a block.
   1) In one example, at least one hypothesis in GPM is a generated by CIIP. In other words, at least one hypothesis in GPM is generated as a weighted sum of at least one inter-prediction and one intra-prediction.
   2) In one example, at least one hypothesis in CIIP is a generated by GPM. In other words, at least one hypothesis in CIIP is generated as a weighted sum of at least two inter-predictions. 3) In one example, at least one hypothesis in CIIP is a generated by MMVD.
   4) In one example, at least one hypothesis in CIIP is a generated by affine prediction.
   5) In one example, whether mode X can be used together with CIIP may depend on coding information such as block dimensions.
   6) In one example, whether mode X can be used together with CIIP may be signaled from the encoder to the decoder.
      a) In one example, the signaling may be conditioned by coding information such as block dimensions.
3. In one example, one or more hypotheses of a multiple hypothesis prediction block may be generated based on position dependent prediction combination (e.g., PDPC).
   1) For example, prediction samples of a hypothesis may be processed by PDPC first, before it is used to generate the multiple hypothesis prediction block.
   2) For example, a predictor obtained based on PDPC which takes into account the neighboring sample values may be used to generate a hypothesis.
   3) For example, a predictor obtained based on gradient based PDPC which takes into account the gradient of neighboring samples may be used to generate a hypothesis.
      a) For example, a gradient based PDPC may be applied to an intra mode (Planar, DC, Horizontal, Vertical, or diagonal mode) coded hypothesis.
   4) For example, a PDPC predictor may be not based on a prediction sample inside the current block.
      a) For example, a PDPC predictor may be only based on prediction (or reconstruction) samples neighboring the current block.
      b) For example, a PDPC predictor may be based on both prediction (or reconstruction) samples neighboring the current block and inside the current block.
4. In one example, a multiple hypothesis predicted block may be generated based on decoder side refinement techniques.
   1) For example, a decoder side refinement technique may be applied to one or more hypotheses of a multiple hypothesis prediction block.
   2) For example, a decoder side refinement technique may be applied to a multiple hypothesis prediction block.
   3) For example, the decoder side refinement technique may be based on decoder side template matching (e.g., TM), decoder side bilateral matching (e.g., DMVR), or decoder side bi-directional optical flow (e.g., BDOF) or Prediction Refinement with Optical Flow (PROF).
   4) For example, the multiple hypothesis predicted block may be coded with CIIP, MHP, GPM, or any other multiple hypothesis prediction modes.
   5) For example, the INTER prediction motion data of a multiple hypothesis block (e.g., CIIP) may be further refined by decoder side template matching (TM), and/or decoder side bilateral matching (DMVR), and/or decoder side bi-directional optical flow (BDOF).
   6) For example, the INTER prediction samples of a multiple hypothesis block (e.g., CIIP) may be further refined by decoder side template matching (TM), and/or decoder side bilateral matching (DMVR), and/or decoder side bi-directional optical flow (BDOF) or Prediction Refinement with Optical Flow (PROF).
   7) For example, the INTRA prediction part of a multiple hypothesis block (e.g., CIIP, MHP, and etc.) may be further refined by decoder side mode derivation (e.g., DIMD), decoder side intra template matching, and etc.
   8) The refined intra prediction mode/motion information of a multiple hypothesis block may be disallowed to predict the following blocks to be coded/decoded in the same slice/tile/picture/subpicture.
   9) Alternatively, decoder side refinement techniques may be NOT applied to a multiple hypothesis predicted block.
      a) For example, decoder side refinement techniques may be NOT allowed to an MHP coded block.
5. For block-based multiple hypothesis prediction-coded blocks (e.g., coded with CIIP, MHP), it is proposed to derive the block into multiple subblocks/subpartitions/partitions
   1) In one example, multiple sets of motion information may be signalled/derived.
      a) In one example, for each subblock/subpartition/partitions, one set of motion may be derived.
   2) In one example, the final prediction of a subblock/subparition/partition may be dependent only on the set of motion information associated with it.
      a) Alternatively, the final prediction of a subblock/subparition/partition may be dependent only on more than one set of motion information associated with it.
6. In one example, in case that a multiple hypothesis prediction unit (e.g., coding unit) contains more than one subblock/subpartition/partition wherein the size of each subblock/subpartition/partition is less than the size of the entire multiple hypothesis prediction unit, the following rules may be applied:
   1) For example, the multiple hypothesis prediction unit may be partitioned in a uniform way.
      a) For example, the multiple hypothesis prediction unit may be partitioned in to rectangular or square subblocks.
      b) For example, the multiple hypothesis prediction unit may be partitioned into M×N subblocks.
         i. For example, M=N.
         ii. For example, M !=N.
         iii. For example, M=4 or 8 or 16.
         iv. For example, N=4 or 8 or 16.
         v. For example, M is equal to the width of the entire multiple hypothesis prediction unit, and N is less than the height of the entire multiple hypothesis prediction unit.
         vi. For example, M is less than the width of the entire multiple hypothesis prediction unit, and N is equal to the height of the entire multiple hypothesis prediction unit.
      c) For example, the multiple hypothesis prediction unit may be partitioned into triangle subblocks.
         i. For example, the multiple hypothesis prediction unit may be partitioned into two diagonal triangles.
   2) For example, the multiple hypothesis prediction unit may be partitioned in a nonuniform/irregular way.
      a) For example, the multiple hypothesis prediction unit may be partitioned by an oblique line or a straight line (e.g., GPM partition, etc.).
      b) For example, the multiple hypothesis prediction unit may be partitioned by a curved line.
   3) For example, whether a subblock/subpartition/partition/hypothesis of a multiple hypothesis prediction unit is intra-coded, may be dependent on the partition information of the multiple hypothesis prediction unit.
      a) For example, it may depend on the angle of the partition line.
         i. For example, which GPM partition is intra mode coded may be dependent on the GPM partition mode (or GPM partition angle, or GPM partition distance).
         ii. For example, one or more look-up-table (or mapping table) may be pre-defined for the corresponding relationship between the GPM partition mode (or GPM partition angle, or GPM partition distance) and which subblock/subpartition/partition/hypothesis is intra coded.
      b) For example, it may depend on the number of neighboring samples (outside the entire multiple hypothesis prediction unit) adjacent to the subblock/subpartition/partition/hypothesis (and this also depends on how the multiple hypothesis prediction unit is partitioned).
   4) For example, in case that a subblock/subpartition/partition/hypothesis of the entire multiple hypothesis prediction unit is intra mode coded, what intra modes allowed for the subblock/subpartition/partition/hypothesis may be dependent on the partition information.
      a) For example, whether to use horizontal intra mode, vertical intra mode, diagonal intra mode, or other intra mode may be dependent on the partition information of the multiple hypothesis prediction unit.
      b) For example, a pre-defined intra mode set may be defined depending on whether above and/or left neighbor samples are available for this subblock/subpartition/partition/hypothesis.
         i. For example, horizontal or near horizontal intra modes may be not allowed when a subblock/subpartition/partition/hypothesis doesn't have left neighboring samples outside the entire multiple hypothesis coding unit but adjacent to the current subblock/subpartition/partition/hypothesis (the size of a subblock/subpartition/partition/hypothesis partition is less than the multiple hypothesis coding unit).
         ii. For example, vertical or near vertical intra modes may be not allowed when a subblock/subpartition/partition/hypothesis doesn't have above neighboring samples outside the entire multiple hypothesis coding unit but adjacent to the current subblock/subpartition/partition/hypothesis.
      c) For example, what intra modes are allowed for a GPM partition may be dependent on the GPM partition mode (or GPM partition angle, or GPM partition distance).
         i. For example, a pre-defined intra mode set may be defined depending on the GPM partition shape/angle/distance/mode.
         ii. For example, one or more look-up-table (or mapping table) may be pre-defined for the corresponding relationship between the GPM partition mode (or GPM partition angle, or GPM partition distance) and what intra modes are allowed for the intra coded subblock/subpartition/partition/hypothesis.
         a) For example, at most one intra mode may be allowed for a GPM partition.
         b) For example, a set of pre-defined intra modes may be allowed for a GPM partition.
         iii. Additionally, what intra mode is used for a GPM partition may be dependent on the available neighboring samples outside the entire GPM coding unit but adjacent to the current GPM partition (the size of a GPM partition is less than the GPM coding unit).
         a) For example, if a GPM partition doesn't have left neighboring samples but have above neighboring samples adjacent to the current GPM partition, horizontal or near horizontal intra modes which predicting from left to right may be allowed for the current GPM partition.
         b) For example, if a GPM partition doesn't have above neighboring samples but have left neighboring samples adjacent to the current GPM partition, vertical or near vertical intra modes which predicting from up to down may be allowed for the current GPM partition.
         c) For example, if a GPM partition have neither above neighboring samples nor left neighboring samples adjacent to the current GPM partition, intra mode be NOT allowed for the current GPM partition.
         i. Alternatively, in such case, a specific intra mode other than horizontal/vertical/near-horizontal/near-vertical intra mode may be allowed for the current GPM partition.
   5) In one example, the hypothesis prediction unit may not be partitioned into subblock/subpartition/partition in a sharp-cut way. Instead, the way of splitting subblock/subpartition/partition may be used to determine the weighting values for prediction samples in the unit.
      a) A unit is partitioned into subblock/subpartition/partition in a sharp-cut way if it is partitioned in multiple subblocks/subpartitions/partitions and prediction samples for each subblock/subpartition/partition are derived independently.
      b) A unit is NOT partitioned into subblock/subpartition/partition in a sharp-cut way if it is partitioned in multiple subblocks/subpartitions/partitions conceptually, but prediction samples for each subblock/subpartition/partition are NOT derived independently.
      c) In one example, a first weighting value for a first prediction on a first position in a first subblock/subpartition/partition may be larger than a second weighting value for a first prediction on a second position in a second subblock/subpartition/partition.
         i. For example, the first prediction may be intra-prediction, the first subblock/subpartition/partition may be regarded as an intra-coded subblock/subpartition/partition and the second subblock/subpartition/partition may be regarded as an intra-coded subblock/subpartition/partition.
      d) Alternatively, furthermore, indication of partitioning information is not signalled anymore in such case.
   6) In one example, the derivation of weighting values used in multiple hypothesis prediction may depend on whether a hypothesis prediction unit (e.g., coding unit) contains more than one subblock/subpartition/partition.
      a) In one example, the weighting values may be derived on the relative sample positions in each subblock/subpartition/partition.
         i. In one example, a first weighting value on a first relative sample position in a first subblock/subpartition/partition, may be equal to a second weighting value on the same relative sample position in a second subblock/subpartition/partition.
      b) Alternatively, the weighting values may be derived toward the relative sample positions in the whole hypothesis prediction unit.
      c) In one example, different weighing values may be used for different dimensions of subblock/subpartition/partitions.
   7) The partitioning/weighting values used in the multiple hypothesis prediction-coded blocks may depend on coded information, color component, color formats, etc. al.
      a) In one example, the chroma components follow the partitioning rules applied to luma component.
         i. Alternatively, the chroma components have different partitioning rules that are applied to luma component.
      b) In one example, the chroma components follow the weighting value derivation rules applied to luma component.
         i. Alternatively, furthermore, the weighting values applied to chroma components may be shared/derived from that for luma component.
   8) The above methods may be also applied to those bullets mentioned in bullet 5.

CIIP/MHP Inter Components
7. For example, a virtual/generated motion data (e.g., including motion vectors, prediction directions, reference indices, etc.) may be used for multiple hypothesis prediction (e.g., CIIP, MHP, GPM, and etc.)
   1) The virtual/generated motion data may be generated in a basic-block by basic-block manner. For example, a basic-block may be a 4×4 block.
      a) In one example, the motion data of a basic-block may depend on how the hypothesis prediction is conducted on this basic-block, such as the weighting values on this basic-block, the partitioning methods on this basic-block, the motion data of one prediction of the multiple hypothesis predictions on this basic-block and so on.
   2) For example, the prediction direction (L0, L1 or bi) may be derived according to pre-defined rules.
      a) For example, if only motion information for L0 can be found in all hypothesis prediction for a basis-block, the prediction direction of the basis-block may be set to uni-prediction L0.
      b) For example, if only motion information for L0 can be found in all hypothesis prediction for a basis-block, the prediction direction of the basis-block may be set to uni-prediction L1.
      c) For example, if motion information for both directions can be found in all hypothesis prediction for a basis-block, the prediction direction of the basis-block may be set to bi.
   3) For example, the virtual/generated motion may be a bi-predicted motion created according to pre-defined rules.
      a) For example, the virtual/generated BI-motion may be constructed from an L0 motion of a candidate from a first candidate list, and an L1 motion of a candidate from a second candidate list.
         i. For example, the first candidate list and/or the second candidate list may be pre-defined.
         ii. For example, the first candidate list may be AMVP candidate list, MERGE candidate list, a new candidate list constructed based on GPM/AMVP/MERGE candidates, or any other motion candidate lists.
         iii. For example, the second candidate list may be MERGE candidate list, AMVP candidate list, a new candidate list constructed based on GPM/AMVP/MERGE candidates, or any other motion candidate lists.
         iv. Additionally, the first candidate list is different from the second candidate list.
         v. Additionally, the first candidate list may be the same as the second candidate list.
   4) For example, the virtual/generated motion may be a uni-predicted motion created following pre-defined rules.
      a) For example, the virtual/generated uni-motion may be constructed from L0 or L1 motion of a candidate from a third candidate list.
         i. For example, the third candidate list may be AMVP candidate list, MERGE candidate list, a new candidate list constructed based on GPM/AMVP/MERGE candidates, or any other motion candidate lists.
      5) For example, if the L0/L1/BI motion is from a MERGE candidate list, a merge candidate index may be signalled.
         a) Alternatively, the merge candidate index may be implicitly derived from a decoder derived method (e.g., template matching based, or bilateral matching based, etc.)
   6) For example, if the L0/L1/BI motion is from an AMVP candidate list, a motion vector difference (e.g., MVD) may be signalled.
      a) Additionally, an AMVP candidate index may be signalled.
         i. Alternatively, the AMVP candidate index may be implicitly derived from a decoder derived method (e.g., template matching based, or bilateral matching based, etc.)
      b) Alternatively, the motion vector difference may be implicitly derived from a decoder derived method (e.g., template matching based, or bilateral matching based, etc.)
   7) For example, the virtual/generated motion data may be used to generate a prediction block, and the resultant prediction block may be used to compute the final prediction video unit (e.g., multiple hypothesis prediction block, a new coding mode).
      a) Additionally, a motion/sample refinement may be further applied to the generated prediction block.
         i. For example, the motion/sample refinement may be template matching (TM), bilateral matching, decoder derived motion vector refinement (e.g., DMVR), multi-pass decoder derived motion vector refinement (e.g., MPDMVR), BODF, PROF, and etc.
   8) For example, the virtual/generated motion data may be used in succeeding procedures such as de-blocking process.
   9) For example, the virtual/generated motion data may be used to predict motion data in succeeding blocks.

CIIP/MHP Intra Components
8. For example, the intra part of a multiple hypothesis prediction block (e.g., CIIP, MHP, GPM, etc) may be determined based on a pre-defined rule.
   1) For example, the intra part of a multiple hypothesis prediction block (e.g., CIIP, MHP, GPM, etc) may be derived based on a fusion based intra prediction.
      a) For example, the fusion based intra prediction may refer to a prediction block blended from more than one intra mode.
      b) For example, the fusion based intra prediction may be generated by the first X intra modes from a pre-defined intra mode set.
         i. For example, the first X (such as X>1) intra modes may be the modes with lowest cost.
         a) Furthermore, the cost may be calculated based on a template matching method, or a bilateral matching method.
         i. For example, a template matching based method may be used to sort a set of pre-defined intra modes and select the best X modes as for the intra part of a multiple hypothesis block.
         b) Furthermore, the cost may be calculated based on a quality metric (e.g., SAD/SATD/MSE, etc) using information of neighbording samples.
         c) Furthermore, the cost may be calculated based on the histogram of gradient (HoG) from neighboring samples.
         ii. For example, the pre-defined intra mode set may comprise Planar mode, and/or regular intra modes, and/or intra modes from MPM list, etc.
      c) For example, weights for multiple prediction samples blending/fusion may be dependent on the intra prediction angles/directions.
         i. Additionally, weights for multiple prediction samples blending/fusion may be dependent on the GPM partition modes, and/or GPM partition angles, and/or GPM partition distances.
      d) For example, weights for multiple prediction samples blending/fusion may be block/partition/subblock based (e.g., different block/partition/subblock may have different weights).
         i. Alternatively, weights for multiple prediction samples blending/fusion may be sample based (e.g., different weights may be assigned to different samples).
9. For example, the intra part of a multiple hypothesis prediction block (e.g., CIIP, MHP, GPM, etc) may be determined based on decoder-derived method.
   1) In one example, it may be determined by decoder intra-prediction mode derivation (DIMD).
   2) In one example, it may be determined by template-based intra-prediction mode derivation (TIMD).

Weighting Factors Design and Storage
10. In one example, in case of blending an intra predicted sample with another prediction sample (could be inter coded, or intra code, or a prediction sample blended from others), what blending/fusion weights are used may be dependent on coding information.
   1) For example, the rules for deriving blending weights may depend on the prediction modes of the samples being blended.
      a) For example, different hypothesis combination (such as “intra+intra”, “intra+inter”, or “inter+inter”) may be different.
   2) For example, the blending weights of intra and inter/intra may be dependent on the prediction mode of one of the intra predicted sample being used for blending/fusion.
   3) For example, more than one set of blending/fusion weights may be defined for a specific fusion method, based on what intra mode is used for a video unit.
      a) For example, different weight sets may be defined based on the classification according to intra mode such as horizontal mode, vertical mode, wide-angle modes, diagonal mode, anti-diagonal mode, intra modes in which the samples are predicted from top and left neighboring samples (e.g., intra mode indices corresponding to angular greater than horizontal, intra mode index less than 18), intra modes in which the samples are predicted from top neighboring samples (e.g., intra mode indices corresponding to angular less than vertical, intra mode index greater than 50), intra modes in which the samples are predicted from left neighboring samples (e.g., intra mode index greater than horizontal (such as 18) but less than vertical (such as 50)), and etc.
      b) For example, the weight settings may be based on the rule of weights definition/classification in an existing coding tool such as PDPC, CIIP, and etc.
   4) For example, more than one set of blending/fusion weights may be defined for a specific fusion method, based on which subblock/sub-unit the current sample belongs to.
      a) For example, different samples may have different weights.
      b) For example, samples belong to different subblocks may have different weights.
      c) For example, subblocks may be with non-rectangular shape.
   5) The weighting values may depend on color components.
      a) In one example, weighting values on a first (such as chroma) component may be derive based on corresponding weighting values on a second (such as luma) component
11. For example, intra mode information of a multiple hypothesis prediction block (e.g., GPM, MHP, CIIP, and etc.) may be stored in a basis of M×M unit (such as M=4, or 8, or 16).
   a) For example, for an M×M unit locating at the blending area where all of the subblocks/subpartitions/partitions/hypotheses inside the M×M unit are INTRA coded, intra mode of which subblock/subpartition/partition/hypothesis is stored may depend on (i) the partition information (e.g., partition angle/distance/mode, etc.); (ii) the size of the subblock/subpartition/partition/hypothesis; iii) the intra mode information; (iv) pre-defined rules.
   b) For example, for an M×M unit locating at the blending area which contain both intra coded and inter coded subblocks/subpartitions/partitions/hypotheses, whether to store motion data or the intra mode information, may be dependent on (i) pre-defined rule; (ii) the intra mode information; (iii) the inter motion data; (iv) the partition information (e.g., partition angle/distance/mode, etc.), (v) the size of the subblock/subpartition/partition/hypothesis.
   c) For example, the above-mentioned M×M unit based intra mode storage may be used to a multiple prediction mode which divides a coding unit into more than one subblock/subpartition/partition (e.g., GPM, and etc).
   d) For example, the above-mentioned M×M unit based intra mode storage may be used to a multiple prediction mode which doesn't divide a coding unit into subblocks/subpartitions/partitions (e.g., CIIP, MHP, and etc).
   e) For example, the above-mentioned M×M unit based intra mode storage may be used to predict intra-prediction mode in succeeding blocks.

General Claims
12. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
13. Whether to and/or how to apply the disclosed methods above may be signalled at PB/TB/CB/PU/TU/CU/VPDU/CTU/CTU row/slice/tile/sub-picture/other kinds of region contain more than one sample or pixel.
   Whether to and/or how to apply the disclosed methods above may be dependent on coded information, such as block size, colour format, single/dual tree partitioning, colour component, slice/picture type.

In the present disclosure, GPM specifies a prediction method that splits a coding unit into at least two subpartitons/partitions, and the splitting line may be an oblique line or a straight line. In addition, each partition of a GPM video unit may use an individual prediction method (e.g., intra, inter, non-inter, L0 prediction, or L1 prediction). Alternatively, at least two intermediate prediction blocks are generated with individual prediction methods, and a final prediction block is generated by a weighted sum of the intermediate prediction blocks, wherein the weighting values are determined based on the splitting method. On the other hand, the transform of a GPM video unit is conducted based on the entire video unit rather than subpartiton/partition. In yet another example, the GPM may generate multiple sets of motion information and the final prediction is based on weighted prediction signals from different sets of motion information; or it may generate the final prediction according to mixed prediction methods (e.g., intra/inter/palette/IBC).

GPM Intra-Intra Prediction, GPM Intra-Inter Prediction
14. In one example, the coding information storage of the intra part of a GPM intra-intra prediction (or a GPM intra-inter prediction) may follow below rules:
   1) For example, the coding information may be stored on M×N basis.
      a) For example, M=2 or 4 or 8 luma samples.
      b) For example, M may be equal to non-dyadic values.
      c) For example, N=M.
   2) For example, the coding information storage of the intra coded partition may be stored based on a zero MV.
   3) For example, the coding information storage of the intra coded partition may be stored based on a reference index equal to −1.
   4) For example, the coding information storage of the intra coded partition may be stored based on a reference index equal to a reference index of the current slice/picture.
   5) For example, the coding information storage of the intra coded partition may be stored based on the real intra prediction mode/angle/direction that used to derive the intra prediction.
      a) For example, the real intra prediction mode/angle/direction of a GPM partition may not belong to one of the regular intra mode index.
         i. For example, the real intra prediction mode/angle/direction of a GPM partition may be mapped to one of the regular intra mode index for coding information storage.
      b) Alternatively, the real intra prediction mode/angle/direction that used to derive the intra prediction may not be stored.
         i. For example, the coding information storage of the intra coded partition may be based on a default inter motion (such as zero MV).
      c) Alternatively, the coding information storage of the intra coded partition may be based on a default intra mode (not necessarily the intra mode index used for the partition).
         i. For example, the default intra mode may be Planar mode.
   6) For example, at the blending area (e.g., intra-inter fusion area that along the GPM partition line), whether to store intra coded information or inter coded information may be predefined.
      a) In one example, if a sample belong to a blending area, then more than one weighting values used in GPM for that sample are not equal to 0.
      b) For example, the intra coded information may be always stored.
      c) For example, the inter coded information may be always stored.
      d) Alternatively, whether to store intra or inter coded information may be dependent on the partition information (partition line, partition mode index, partition angle, partition distance, etc).
   7) For example, at the blending area (e.g., intra-intra fusion area that along the GPM partition line), the coded information of which partition is stored may be predefined.
      a) In one example, if a sample belong to a blending area, then more than one weighting values used in GPM for that sample are not equal to 0.
      b) Alternatively, whether to store the first or the second partition coded information may be dependent on the partition information (partition line, partition mode index, partition angle, partition distance, etc).
      c) In one example, whether to store the first or the second partition coded information may be dependent on the two intra-prediction modes.
   8) For example, the stored coding information of a GPM intra partition may be used by succeeding coded/decoded blocks, such as for MPM list construction of a coding unit succeeding the current GPM block.
   9) For example, the stored coding information of a GPM intra partition may be used for deblocking process.
15. In one example, a multiple hypothesis prediction block may be generated based on more than one Intra prediction.
   1) For example, more than one hypothesis of a multiple hypothesis prediction block (e.g., entire block based, or subblock/partition based) may be intra predicted.
      a) For example, an MHP block may comprise more than one intra coded hypothesis.
      b) For example, a CIIP block may comprise at least two intra predictions.
      c) For example, both partitions of a GPM block may be intra mode coded.
      d) For example, intra modes of the two partitions may be not allowed to the same.
      e) For example, the intra mode of one of the two partitions may be signalled in the bitstream.
         i. For example, the intra mode of the other partition may be implicitly derived.
         ii. For example, the intra mode of a first partition may be excluded from the coded representation of the second partition.
      f) For example, intra modes of the two partitions may be signalled in the bitstream.
      g) For example, intra modes of the two partitions may be implicitly derived.
      h) For example, two intra predictions of the two partitions may be weighted blended.
         i. For example, two intra predictions of a GPM block may be weighted blended.
         ii. For example, all samples within a partition may have same weighting factor.
         iii. For example, different samples may have different weighting factors.
         iv. For example, the weighting values may depend on the splitting method of the GPM block.
         v. For example, the weighting values may depend on at least one intra-prediction mode.
   2) For example, the multiple hypothesis prediction block may be split by one or more oblique or straight partition lines (e.g., a GPM partition line).
      a) For example, the splitting modes (angle, direction, partition mode index) may be signalled in the bitstream.
      b) For example, the slitting modes may be signalled in the same way as GPM partition mode index.
      c) For example, the splitting modes may be implicitly derived based on coding information.
   3) For example, one or more syntax elements (e.g., flag) may be signalled indicating whether the intra prediction of a certain (GPM) partition is derived at the decoder side.
      a) For example, a CU based flag may be siganlled for the entire block.
   b) For example, a partition-based flag may be signalled for a certain partition of the block.
   c) For example, the decoder derived intra prediction may be DIMD, or TIMD, etc.
16. In one example, a multiple hypothesis prediction block may be allowed for P slice/picture wherein only L0 reference list is available, and/or B slice/picture wherein both L0 and L1 reference lists are available.
   1) For example, GPM may be allowed for P slice/picture.
   2) For example, the two partitions of a GPM block may be an intra prediction and an inter prediction (a.k.a. GPM intra-inter block).
      a) For example, the inter prediction may be L0 prediction or L1 prediction.
      b) For example, the intra mode of the partition may be predefined or signalled.
   3) For example, the two partitions of a GPM block may be an intra prediction and another intra prediction.
      a) For example, the intra modes of the two partitions may not be allowed to be the same.
   4) For example, the two partitions of a GPM block may be an inter prediction and another inter prediction.
      a) For example, a GPM block may comprise two L0 predictions.
      b) For example, a GPM block may comprise two L1 predictions.
      c) For example, the motion information (e.g., merge index, motion vector, reference index, etc) of the two predictions may not be allowed to be the same.
      d) For example, when the two partitions are predicted from a same prediction direction (e.g., L0 or L1), the motion vector of the two partitions may be added together or averaged for blended area motion storage.
         i. For example, if the prediction direction and the reference index of the two partitions are same, motion vectors of the two partitions may be directly added together or averaged for motion storage of the blended area.
         ii. For example, if the prediction direction of the two partitions are same but the reference indexes are different, motion storage of the blended are may be based on a motion vector scaling process.
      e) For example, when the two partitions are predicted from a same prediction direction (e.g., L0 or L1), the motion vector of the partition with a smaller reference index may be stored.
      f) For example, when the two partitions are predicted from a same prediction direction (e.g., L0 or L1), the motion vector of the partition with a smaller |MVx|+|MVy| may be stored.
   5) For example, a GPM candidate list may be constructed based on regular merge candidates who has a specific prediction direction such as L0
   6) For example, a GPM candidate list for P slice may be constructed in a different way of the GPM candidate list for B slice.
      a) For example, a GPM candidate list for P slice may be a subset of the GPM candidate list for B slice.
17. For example, whether CU based GPM template matching syntax elements (e.g., a flag) are signalled or not may be dependent/conditioned on whether intra-inter coding (e.g., one partition is intra coded and the other partition is inter coded) is used for a GPM block.
   1) For example, in case that a GPM block is coded by intra-inter prediction, the CU based GPM template matching (in which both GPM partitions are refined by template matching) may be not allowed to be further applied.
      a) For example, in case that CU based GPM template matching is not allowed for a GPM intra-inter block, the CU level TM based flag is not signalled by inferred to a certain value.
   2) Alternatively, whether intra-inter coding is allowed for a GPM block may be dependent/conditioned on whether CU based GPM template matching is used for the block.
      a) For example, in case that a CU based GPM template matching is used, the GPM intra-inter prediction may be not allowed to be further applied.
      b) For example, in case that the GPM intra-iter prediction is not allowed for a GPM block, the intra coded information is not signalled in the bitstream.
   3) Alternatively, a GPM intra-inter block may be allowed to use partition-based GPM template matching (in which the inter coded GPM partition is allowed to be refined by template matching).
      a) For example, in case that a partition-based GPM template matching is allowed for a GPM intra-inter block (the partition-based GPM template matching is allowed to be applied to the inter coded partition), a flag may be signalled for the inter coded partition specifying whether the motion of the partition is further refined by template matching.
18. In one example, a multiple hypothesis prediction block may be allowed for I slice/picture.
   1) For example, GPM may be allowed for I slice/picture.
      a) For example, a GPM block may comprise two non-Inter predictions.
      b) For example, the non-Inter prediction may be intra prediction, IBC, or Palette prediction.
      c) For example, different intra modes may be used for the two partitions of a GPM block.
      d) For example, sample-based weighting factor may be used to blend/fusion the two partitions of a GPM block.
   2) For example, CIIP may be allowed for I slice/picture.
      a) For example, a CIIP block may comprise an Intra prediction and a non-Inter prediction.
      b) For example, the non-Inter prediction may be intra prediction, IBC, or Palette prediction.
      c) For example, different intra modes may be used for the two predictions of a CIIP block.
      d) For example, block-based weighting factor may be used to blend/fusion the two predictions of a CIIP block.
   3) For example, MHP may be allowed for I slice/picture.
      a) For example, an MHP boclk may comprise multiple non-Inter predictions.
      b) For example, the non-Inter prediction may be intra prediction, IBC, or Palette prediction.
      c) For example, different intra modes may be used for the multiple hypotheses of an MHP block.
      d) For example, block-based weighting factor may be used to blend/fusion the multiple hypotheses of an MHP block.
   4) Information for IBC such as BV may be signaled if IBC is involved in GPM/CIIP/MHP.
   5) Information for Palette such as palette indices may be signaled if Palette is involved in GPM/CIIP/MHP.

Misc.
19. In one example, for a specific coding method, the shape of a template used for a video unit may be dependent on the availability of neighboring samples.
   1) When above samples are available but left samples are not available (e.g., template exceed the picture left boundary, or the current block locates at the first row of the picture), a template comprises above samples only.
   2) When left samples are available but above samples are not available (e.g., template exceed the picture above boundary, or the current block locates at the first column of the picture), a template comprises left samples only.
   3) When left samples and above samples are not available (e.g., the current block locates at the first row and first column of the picture), no template is used.
   4) Alternatively, a virtual template may be used, in which at least one sample of the template is generated by a specific mean (such as fill with a default sample value dependent on the internal bit depth).
      a) In one example, padding may be utilized to fill in samples which are unavailable.
   5) The template may be used for template matching based MV/BV derivation.
   6) The template may be used for template matching based intra-prediction derivation.
20. In one example, filter coefficients, clipping values may be allowed to be a value not equal to a power of 2.
   1) In one example, the filter coefficients of CCALF may be based on a value not equal to a power of 2.
   2) In one example, clipping values (e.g., non-linear clipping in ALF, etc) of a certain coding tool may not be a power of 2.
21. In one example, chroma and luma may share similar filter shape.
   1) The filter shape may be the same, however, the filter length may be different.
   2) For example, assume M×N diamond/cross shape filter is used for the luma components of a loop filter (e.g., ALF, CCALF, etc), its associated chroma components may be allowed to use a similar diamond/cross shape filter with a size of (M>>SubWidthC)×(N>>SubHeightC), wherein SubWidthC and SubHeightC depending on the chroma format sampling structure.
      a) For example, SubWidthC=SubHeightC=2 for 4:2:0 chroma format.
      b) For example, SubWidthC=SubHeightC=1 for 4:4:4 chroma format.
      c) For example, SubWidthC=2 and SubHeightC=1 for 4:2:2 chroma format.
   3) In one example, chroma and luma may share same filter shape if the chroma format is 4:4:4.

General Claims
22. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
23. Whether to and/or how to apply the disclosed methods above may be signalled at PB/TB/CB/PU/TU/CU/VPDU/CTU/CTU row/slice/tile/sub-picture/other kinds of region contain more than one sample or pixel.
24. Whether to and/or how to apply the disclosed methods above may be dependent on coded information, such as block size, colour format, single/dual tree partitioning, colour component, slice/picture type.

Embodiments of the present disclosure are related to prediction blended from multiple compositions in image/vide coding.

As used herein, the terms “video unit” or “coding unit” or “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

In this present disclosure, regarding “a block coded with mode N”, the term “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, MMVD, BCW, HMVP, SbTMVP, and etc.).

A “multiple hypothesis prediction” in this present disclosure may refer to any coding tool that combining/blending more than one prediction/composition/hypothesis into one for later reconstruction process. For example, a composition/hypothesis may be INTER mode coded, INTRA mode coded, or any other coding mode/method like CIIP, GPM, MHP, and the like.

In the following discussion, a “base hypothesis” of a multiple hypothesis prediction block may refer to a first hypothesis/prediction with a first set of weighting values. In the following discussion, an “additional hypothesis” of a multiple hypothesis prediction block may refer to a second hypothesis/prediction with a second set of weighting values.

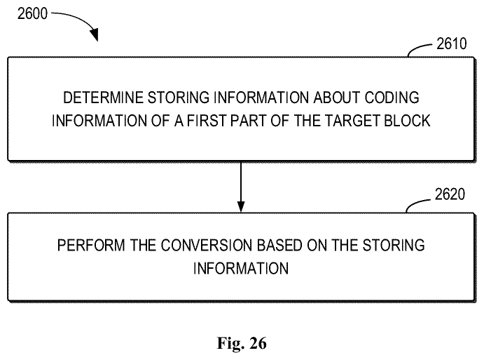

FIG. 26 illustrates a flowchart of a method 2600 for video processing in accordance with some embodiments of the present disclosure. The method 2600 may be implemented during a conversion between a video unit and a bitstream of the video unit.

As shown in FIG. 26, at block 2610, during a conversion between a target block of a video and a bitstream of the target block, storing information about coding information of a first part of the target block is determined. The target block is coded with a geometric partitioning mode (GPM). The first part of the target block may comprise an intra coded partition of the target block. For example, if the target block is a GPM intra-intra prediction block, the first part may comprise the intra part of the GPM intra-intra prediction block. Alternatively, if the target block is a GPM intra-inter prediction block, the first part may comprise the intra part of the GPM intra-inter prediction block.

At block 2620, the conversion is performed based on the storing information. In some embodiments, the storing information may indicate how to store the coding information of the first part of the target block. In some other embodiments, the storing information may indicate whether to store the coding information of the first part of the target block. In some embodiments, the conversion may comprise ending the target block into the bitstream. Alternatively, the conversion may comprise decoding the target block from the bitstream.

According to embodiments of the present disclosure, the coding information storage of the intra part of the block can be properly stored. Compared with the conventional solution, some embodiments of the present disclosure can advantageously improve improving the coding efficiency, coding performance, and flexibility.

Implementations of the present disclosure can be described in view of the following clauses, the features of which can be combined in any reasonable manner

In some embodiments, the coding information may be stored on a M×N basis. In this case, M and N may represent numbers of samples, respectively. In some embodiments, M may equal to one of the followings: 2 luma samples, 4 luma samples, or 8 luma samples. Alternatively, M may be a non-dyadic value. In some embodiments, M and N may be the same.

In some embodiments, the coding information of the first part of the target block may be stored based on a zero motion vector. In some embodiments, the coding information of the first part of the target block may be stored based on a reference index equal to −1.

In some embodiments, the coding information of the first part of the target block may be stored based on a reference index which equals to a reference index of a current slice or a current picture associated with the target block. In some embodiments, the coding information of the first part of the target block may be stored based on at least one of the followings: a real intra prediction mode used to derive an intra prediction of the target block, an angle used to derive the intra prediction of the target block, or a direction used to derive the intra prediction of the target block. In some embodiments, one or more of the following may not belong to one of a regular intra mode index: the real intra prediction mode, the angle, or the direction. In some embodiments, one or more the followings may be mapped to one of a regular intra mode index for storing coding information: the real intra prediction mode, the angle, or the direction. In some embodiments, one or more of the followings may not be stored: the real intra prediction mode, the angle, or the direction.

In some embodiments, the coding information of the first part of the target block may be stored based on a default inter motion. For example, the default inter motion may be zero motion vector.

In some other embodiments, the coding information of the first part of the target block may be stored based on a default intra mode. For example, the default intra mode may be a planar mode.

In some other embodiments, at a blending area of the target block, whether to store intra coded information of the target block or inter coded information of the target block may be predefined. For example, the blending area of the target may refer to an intra-inter fusion area that is along a GPM partition line. In some other embodiments, if a sample belongs to the blending area, a plurality of weighting values used in GPM for the sample may not equal to 0.

In some other embodiments, the intra coded information of the target block may be stored by default. In other words, the intra coded information may be always stored. In some other embodiments, the inter coded information of the target block may be stored by default. In other words, the inter coded information may be always stored.

In some other embodiments, whether to store intra coded information of the target block or inter coded information of the target block may be determined based on partition information of the target block. For example, the partition information may comprise one or more of: a partition line, a partition mode index, a partition angle, or a partition distance.

In some other embodiments, at a blending area of the target block, coded information of which partition is stored may be predefined. For example, if a sample belong to the blending area, a plurality of weighting values used in GPM for the sample may not equal to 0.

In some other embodiments, whether to store the coded information of the first part or coded information of a second part may be determined based on partition information of the target block. As mentioned above, the partition information may comprise at least one of: a partition line, a partition mode index, a partition angle, or a partition distance. In some other embodiments, whether to store the coded information of the first part or coded information of a second part may be determined based on two intra-prediction modes.

In some other embodiments, the coding information may be used by succeeding coded blocks or succeeding decode block. Alternatively, the coding information may be used for a deblocking process.

In some embodiments, an indication of whether to and/or how to determine storing information about the coding information may be indicated at one of the followings: sequence level, group of pictures level, picture level, slice level, or tile group level. In some embodiments, an indication of whether to and/or how to apply the coding tool may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine storing information about the coding information may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to determine storing information about the coding information may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, storing information about coding information of a first part of the target block which is coded with a GPM is determined, and a bitstream of the target block is generated based on the storing information.

In some embodiments, storing information about coding information of a first part of the target block is determined and the target block is coded with a GPM. A bitstream of the target block is generated based on the storing information, and the bitstream is stored in a non-transitory computer-readable recording medium.

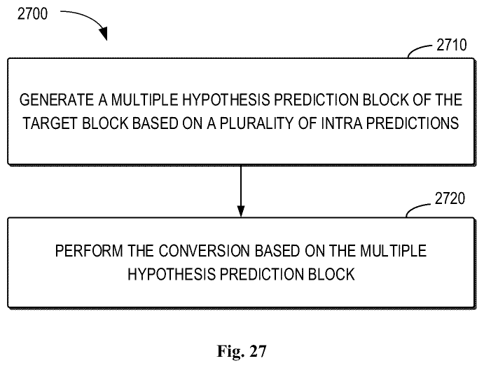

FIG. 27 illustrates a flowchart of a method 2700 for video processing in accordance with some embodiments of the present disclosure. The method 2700 may be implemented during a conversion between a video unit and a bitstream of the video unit.

As shown in FIG. 27, at block 2710, during a conversion between a target block of a video and a bitstream of the target block, a multiple hypothesis prediction block of the target block is generated based on a plurality of intra predictions.

At block 2720, the conversion is performed based on the multiple hypothesis prediction block. In some embodiments, the conversion may comprise ending the target block into the bitstream. Alternatively, the conversion may comprise decoding the target block from the bitstream.

According to embodiments of the present disclosure, it proposes improved the coding method for a multiple hypothesis prediction block. Compared with the conventional solution, some embodiments of the present disclosure can advantageously improve the coding efficiency and coding performance.

Implementations of the present disclosure can be described in view of the following clauses, the features of which can be combined in any reasonable manner

In some embodiments, a plurality of hypothesizes of the multiple hypothesis prediction block may be intra predicted. For example, more than one hypothesis of a multiple hypothesis prediction block (for example, entire block based, or subblock/partition based) may be intra predicted.

In some embodiments, the multiple hypothesis prediction block may be a multi-hypothesis prediction (MHP) block. In some embodiments, the MHP block may comprise a plurality of intra coded hypothesizes.

In some embodiments, the multiple hypothesis prediction block may be a combined inter and intra prediction (CIIP) block. In some embodiments, the CIIP block may comprise at least two intra predictions.

In some embodiments, the multiple hypothesis prediction block may be a geometric partitioning mode (GPM) block. In some embodiments, both partitions of the GPM block may be intra mode coded. In some embodiments, intra modes of two partitions of the GPM block may not be allowed to be the same. In some embodiments, a first intra mode of a first partition of the GPM block may be indicated in the bitstream. In some embodiments, a second intra mode of a second partition of the GPM block may be implicitly derived. In some other embodiments, the first intra mode of the first partition may be excluded from coded representation of the second partition.

In some embodiments, the multiple hypothesis prediction block may be a GPM block. In some embodiments, intra modes of two partitions of the GPM block may be indicated in the bitstream. In some other embodiments, intra modes of two partitions of the GPM block may be implicitly derived.

In some embodiments, two intra predictions of two partitions may be weighted blended. For example, in some embodiments, the multiple hypothesis prediction block may be a GPM block, and two intra predictions of the GPM block may be weighted blended. In some embodiments, all samples within in a partition of the two partitions may have a same weighting factor. In some other embodiments, different samples may have different weighting factors. In some embodiments, a weighting factor may depend on a splitting method of the GPM block. For example, a weighting factor may depend on at least one intra-prediction mode of the multiple hypothesis prediction block.

In some embodiments, the multiple hypothesis prediction block may be split by at least one oblique partition line. Alternatively, the multiple hypothesis prediction block may be split by at least one straight partition line. For example, the multiple hypothesis prediction block may be split by a GPM partition line. In some embodiments, a splitting mode of the target block may be indicated in the bitstream. In some other embodiments, a splitting mode of the target block may be indicated in a same way as GPM partition mode index. Alternatively, a splitting mode of the target block may be implicitly derived based on coding information of the target block.

In some other embodiments, at least one syntax element indicating whether an intra prediction of a certain partition is derived at the decoder side may be indicated. In some embodiments, one or more syntax elements may comprise one or more flags. In some embodiments, the certain partition may be a GPM partition. For example, a CU based flag may be indicated for the target block. In some other embodiments, a partition based flag may be indicated for a partition the target block. In some other embodiments, a decoder derived intra prediction may comprise a decoder side intra mode derivation. Alternatively, the decoder derived intra prediction may comprise a template-based intra mode derivation.

In some other embodiments, if only L0 reference list is available, the multiple hypothesis prediction block may be allowed for P slice or picture. Alternatively, or in addition, if both L0 reference list and L1 reference list, the multiple hypothesis prediction block may be allowed for B slice or picture.

In some other embodiments, the multiple hypothesis prediction block may be a GPM block. In some embodiments, the GPM block may be allowed for P slice or picture. In some embodiments, two partitions of the GPM block may comprise an intra prediction and an inter prediction. For example, the GPM block may be a GPM intra-inter block.

In some embodiments, the inter prediction may comprise a L0 prediction or a L1 prediction. In some other embodiments, the intra prediction may be predefined or indicated.

In some embodiments, two partitions of the GPM block may comprise a first intra prediction and a second intra prediction. In some embodiments, the intra modes of the two partitions may not be allowed to be the same.

Alternatively or in addition, two partitions of the GPM block may comprise a first inter prediction and a second inter prediction. For example, in some embodiments, the GPM block may comprise two L0 predictions. Alternatively, the GPM block may comprise two L1 predictions.

In some embodiments, motion information of the first inter prediction and the second inter predication may not be allowed to be the same. For example, the motion information may comprise one or more of: a merge index, a motion vector, or a reference index. It should be noted that the motion information may also comprise other information.

In some embodiments, if the two partitions are predicted from a same predication direction (for example, L0 or L1), motion vectors of the two partitions may be added together or averaged for blended area motion storage. For example, if the prediction direction and the reference index of the two partitions are same, the motion vectors of the two partitions may be directly added together or averaged for motion storage of the blended area. Alternatively, if a prediction direction of the two partitions is same and reference indexes of the two partitions are different, motion storage of the blended area may be based on a motion vector scaling process. In some other embodiments, if two partitions of the multiple hypothesis prediction block are predicted from a same prediction direction, a motion vector of a target partition with a smaller reference among the two partitions index may be stored. In some embodiment, if two partitions of the multiple hypothesis prediction block are predicted from a same prediction direction, a motion vector of a target partition with a smaller |MVx|+|MVy| may be stored. The MVx and MVy may represent motion vectors in two directions, repectively.

In some embodiments, a GPM candidate list may be constructed based on regular merge candidates of which have a specific prediction direction. Alternatively, a first GPM candidate list for P slice may be constructed in a difference way from a second GPM candidate list for B slice. For example, the first GPM candidate list for P slice may be a subset of the second GPM candidate list for B slice.

In some embodiments, the multiple hypothesis prediction block may be allowed for I slice or picture. For example, the multiple hypothesis prediction block may be a GPM block, and the GPM block may be allowed for I slice or picture. In some embodiments, the GPM block may comprise two non-inter predictions. For example, one of the two non-inter prediction may comprise one of: an intra prediction, an intra block copy, or a palette prediction. In some embodiments, different intra modes may be used for two partitions of the GPM block. In some embodiments, a sample based weighting factor may be sued to blend two partitions of the GPM block.

In some embodiments, the multiple hypothesis prediction block may be a CIIP block. The CIIP block may be allowed for I slice or picture. For example, the CIIP block may comprise an intra prediction and a non-inter prediction. In some embodiments, the non-inter prediction may comprise one of: an intra prediction, an intra block copy, or a palette prediction. In some other embodiments, different intra modes may be used for two predictions of the CIIP block. Alternatively or in addition, a block-based weighting factor may be used to blend two predictions of the CIIP block.

In some other embodiments, the multiple hypothesis prediction block may be a MHP block. The MHP block may be allowed for I slice or picture. In some embodiments, the MHP block may comprise multiple non-inter predictions. For example, the multiple non-inter prediction may comprise one of: an intra prediction, an intra block copy, or a palette prediction. In some embodiments, different intra modes may be used for multiple hypotheses of the MHP block. Alternatively or in addition, a block-based weighting factor may be used to blend multiple hypotheses of the MHP block.

In some other embodiments, if IBC is involved in one of: GPM, CIIP or MHP, information for the IBC may be indicated. Alternatively, if palette is involved in one of: GPM, CIIP or MHP, information for the palette may be indicated.

In some embodiments, an indication of whether to and/or how to generate the multiple hypothesis prediction block may be indicated at one of the followings: sequence level, group of pictures level, picture level, slice level, or tile group level. In some embodiments, an indication of whether to and/or how to apply the coding tool may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to generate the multiple hypothesis prediction block may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to generate the multiple hypothesis prediction block may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, a multiple hypothesis prediction block of the target block is generated based on a plurality of intra predictions, and a bitstream of the target block is generated based on the multiple hypothesis prediction block.

In some embodiments, a multiple hypothesis prediction block of the target block is generated based on a plurality of intra predictions. A bitstream of the target block is generated based on the multiple hypothesis prediction block, and the bitstream is stored in a non-transitory computer-readable recording medium.

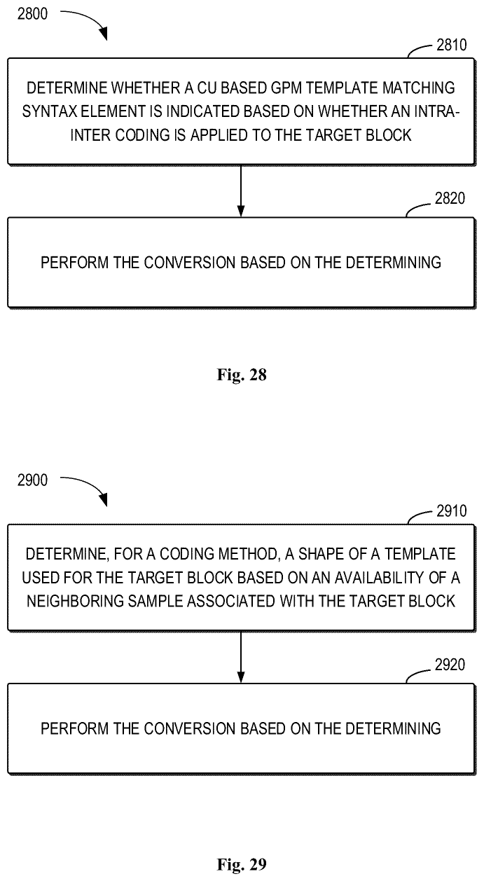

FIG. 28 illustrates a flowchart of a method 2800 for video processing in accordance with some embodiments of the present disclosure. The method 2800 may be implemented during a conversion between a video unit and a bitstream of the video unit.

As shown in FIG. 28, at block 2810, during a conversion between a target block of a video and a bitstream of the target block, whether a coding unit (CU) based geometric partitioning mode (GPM) template matching syntax element is indicated is determined based on whether an intra-inter coding is applied to the target block. The target block is a GPM block.

At block 2820, the conversion is performed based on the determining In some embodiments, the conversion may comprise ending the target block into the bitstream. Alternatively, the conversion may comprise decoding the target block from the bitstream.

According to embodiments of the present disclosure, whether the CU based GPM template matching syntax element is indicated is determined. Compared with the conventional solution, some embodiments of the present disclosure can advantageously improve improving the coding efficiency, coding performance, and flexibility.

In some embodiments, if the target block is coded by intra-inter prediction, the CU based GPM template matching may not be allowed to be further applied. For example, for the CU based GPM template matching, both GPM partitions may be refined by template matching. For example, if the CU based GPM template matching is not allowed for a GPM intra-inter block, a CU level template matching based flag may not be indicated by inferring to a certain value.

Alternatively, whether the intra-inter coding is allowed for the target block may be determined based on whether the CU based GPM template matching is used for the target block. In other words, whether intra-inter coding is allowed for a GPM block may be dependent/conditioned on whether CU based GPM template matching is used for the block. For example, in some embodiments, if the CU based GPM template matching is used, the intra-inter prediction may not be allowed to be further applied. Alternatively, in some embodiments, if the intra-inter prediction is not allowed for the target block, intra coded information may not be indicated in the bitstream.

In some other embodiments, a GPM intra-inter prediction block may be allowed to use a partition-based GPM template matching. For example, for the partition-based GPM template matching, the inter coded GPM partition may be allowed to be refined by template matching. For example, in some embodiments, if the partition-based GPM template matching is allowed for the GPM intra-inter block, a flag may be indicated for inter coded partition specifying whether motion of the inter coded partition is further refined by template matching. In other words, if the partition-based GPM template matching is allowed to be applied to the inter coded partition, the flag may be indicated for inter coded partition specifying whether motion of the inter coded partition is further refined by template matching.

In some embodiments, an indication of whether to and/or how to g determine whether the CU based GPM template matching syntax element is indicated may be indicated at one of the followings: sequence level, group of pictures level, picture level, slice level, or tile group level. In some embodiments, an indication of whether to and/or how to apply the coding tool may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine whether the CU based GPM template matching syntax element is indicated may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to determine whether the CU based GPM template matching syntax element is indicated may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, whether a coding unit (CU) based geometric partitioning mode (GPM) template matching syntax element is indicated is determined based on whether an intra-inter coding is applied to the target block, and a bitstream of the target block is generated based on the determining

In some embodiments, whether a coding unit (CU) based geometric partitioning mode (GPM) template matching syntax element is indicated is determined based on whether an intra-inter coding is applied to the target block. A bitstream of the target block is generated based on the determining, and the bitstream is stored in a non-transitory computer-readable recording medium.

FIG. 29 illustrates a flowchart of a method 2900 for video processing in accordance with some embodiments of the present disclosure. The method 2900 may be implemented during a conversion between a video unit and a bitstream of the video unit.

As shown in FIG. 29, at block 2910, during a conversion between a target block of a video and a bitstream of the target block, for a coding method, a shape of a template used for the target block is determined based on an availability of a neighboring sample associated with the target block. In some embodiments, the neighboring samples may comprise above samples. Alternatively, the neighboring samples may comprise left samples.

At block 2920, the conversion is performed based on the determining In some embodiments, the conversion may comprise ending the target block into the bitstream. Alternatively, the conversion may comprise decoding the target block from the bitstream.

According to embodiments of the present disclosure, it proposes improved shape of the template. Compared with the conventional solution, some embodiments of the present disclosure can advantageously improve the coding efficiency and coding performance.

Implementations of the present disclosure can be described in view of the following clauses, the features of which can be combined in any reasonable manner

In some embodiments, above samples may be available but left samples may not be available. For example, the template may exceed the picture left boundary, or the current block may locate at the first row of the picture. In this case, the template may comprise the above samples only.

Alternatively, the left samples may be available, but the above samples may not be available. For example, the template may exceed the picture above boundary, or the current block may locate at the first column of the picture. In this case, the template may comprise the left samples only.

In some other embodiments, the left samples and the above samples may not be available. For example, the current block may locate at the first row and first column of the picture. In this case, no template may be used.

In some embodiments, a virtual template is used in which at least one sample of the template is generated by a specific mean. For example, the specific mean may refer to filling with a default sample value dependent on the internal bit depth. In some embodiments, padding may be utilized to fill in samples which are unavailable.

In some embodiments, the template may be used for one of the followings: a template matching based motion vector (MV), a template matching based block vector (BV) derivation, or a template matching based intra-prediction derivation.

In some embodiments, an indication of whether to and/or how to determine whether the CU based GPM template matching syntax element is indicated may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to determine whether the CU based GPM template matching syntax element is indicated may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, whether a coding unit (CU) based geometric partitioning mode (GPM) template matching syntax element is indicated is determined based on whether an intra-inter coding is applied to the target block, and a bitstream of the target block is generated based on the determining

In some embodiments, whether a coding unit (CU) based geometric partitioning mode (GPM) template matching syntax element is indicated is determined based on whether an intra-inter coding is applied to the target block. A bitstream of the target block is generated based on the determining, and the bitstream is stored in a non-transitory computer-readable recording medium.

In some embodiments, at least one of: a filter coefficient or a clipping value may be allowed to be a value not equal to a power of 2. For example, the filter coefficient of a Cross-Component Adaptive Loop Filter (CCALF) may be based on a value not equal to a power of 2. In some other embodiments, the clipping value of a certain coding tool may not be a power of 2. For example, the clipping value may be related to non-linear clipping in Adaptive Loop Filter (ALF).

In some embodiments, a chroma component and a luma component may share a filter shape. For example, in some embodiments, a first filter shape for chroma and a second filter shape for luma may be the same, but a first filter length for chroma and a second filter length for luma may be different.

In some embodiments, if an M×N diamond/cross shape filter is used for the luma component of a loop filter, the chroma component associated with the luma component may be allowed to use a diamond/cross shape filter with a size of M×N. In some embodiments, M may be larger than SubWidthC, N may be larger than SubHeightC, and the SubWidthC and the SubHeightC may depend on a chroma format sampling structure. In some embodiments, the loop filter may comprise an ALF or a CCALF.

In some embodiments, the SubWidthC and the SubHeightC may equal to 2 for 4:2:0 chroma format. Alternatively, the SubWidthC and the SubHeightC may equal to 1 for 4:4:4 chroma format. In some other embodiments, the SubWidthC may equal to 2 and the SubHeightC may equal to 1 for 4:2:2 chroma format. In some embodiments, if a chroma format is 4:4:4, the chroma component and the luma component may share a filter shape.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: determining, during a conversion between a target block of a video and a bitstream of the target block, storing information about coding information of a first part of the target block, the target block being coded with a geometric partitioning mode (GPM); and performing the conversion based on the storing information.

Clause 2. The method of clause 1, wherein the target block is a GPM intra-intra prediction block, or the target block is a GPM intra-inter prediction block, and the first part of the target block is an intra coded partition of the target block.

Clause 3. The method of clause 1, wherein the coding information is stored on a M×N basis, and wherein M and N represent numbers of samples, respectively.

Clause 4. The method of clause 3, wherein M equals to one of following: 2 luma samples, 4 luma samples, 8 luma samples, or a non-dyadic value.

Clause 5. The method of clause 3, wherein M and N are same.

Clause 6. The method of clause 1, wherein the coding information of the first part of the target block is stored based on a zero motion vector.

Clause 7. The method of clause 1, wherein the coding information of the first part of the target block is stored based on a reference index equal to −1.

Clause 8. The method of clause 1, wherein the coding information of the first part of the target block is stored based on a reference index which equals to a reference index of a current slice or a current picture associated with the target block.

Clause 9. The method of clause 1, wherein the coding information of the first part of the target block is stored based on at least one of the followings: a real intra prediction mode used to derive an intra prediction of the target block, an angle used to derive the intra prediction of the target block, or a direction used to derive the intra prediction of the target block.

Clause 10. The method of clause 9, wherein at least one of the following does not belong to one of a regular intra mode index: the real intra prediction mode, the angle, or the direction.

Clause 11. The method of clause 9, wherein at least one of the followings is mapped to one of a regular intra mode index for storing coding information: the real intra prediction mode, the angle, or the direction.

Clause 12. The method of clause 9, wherein at least one of the followings is not stored: the real intra prediction mode, the angle, or the direction.

Clause 13. The method of clause 1, wherein the coding information of the first part of the target block is stored based on a default inter motion.

Clause 14. The method of clause 1, wherein the coding information of the first part of the target block is stored based on a default intra mode.

Clause 15. The method of clause 14, wherein the default intra mode is a planar mode.

Clause 16. The method of clause 1, wherein at a blending area of the target block, whether to store intra coded information of the target block or inter coded information of the target block is predefined.

Clause 17. The method of clause 16, wherein the blending area comprise an intra-inter fusion area that is along a GPM partition line.

Clause 18. The method of clause 16, wherein if a sample belongs to the blending area, a plurality of weighting values used in GPM for the sample are not equal to 0.

Clause 19. The method of clause 16, wherein the intra coded information of the target block is stored by default.

Clause 20. The method of clause 16, wherein the inter coded information of the target block is stored by default.

Clause 21. The method of clause 1, wherein whether to store intra coded information of the target block or inter coded information of the target block is determined based on partition information of the target block.

Clause 22. The method of clause 1, wherein at a blending area of the target block, coded information of which partition is stored is predefined.

Clause 23. The method of clause 22, wherein if a sample belong to the blending area, a plurality of weighting values used in GPM for the sample are not equal to 0.

Clause 24. The method of clause 22, wherein whether to store the coded information of the first part or coded information of a second part is determined based on partition information of the target block.

Clause 25. The method of clause 21 or 24, wherein the partition information comprises at least one of: a partition line, a partition mode index, a partition angle, or a partition distance.

Clause 26. The method of clause 22, wherein whether to store the coded information of the first part or coded information of a second part is determined based on two intra-prediction modes.

Clause 27. The method of clause 1, wherein the coding information is used by succeeding coded blocks or succeeding decode block, or wherein the coding information is used for a deblocking process.

Clause 28. The method of clause 1, wherein the storing information indicates at least one of: how to store the coding information of the first part of the target block, or whether to store the coding information of the first part of the target block.

Clause 29. The method of any of clauses 1-28, wherein an indication of whether to and/or how to determine how to store the coding information is indicated at one of the followings: sequence level, group of pictures level, picture level, slice level, or tile group level.

Clause 30. The method of any of clauses 1-28, wherein an indication of whether to and/or how to determine how to store the coding information is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 31. The method of any of clauses 1-28, wherein an indication of whether to and/or how to determine how to store the coding information is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 32. The method of any of clauses 1-28, further comprising: determining, based on coded information of the target block, whether to and/or how to determine how to store the coding information, the coded information including at least one of: a block size, a colour format, a single and/or dual tree partitioning, a colour component, a slice type, or a picture type.

Clause 33. A method of video processing, comprising: generating, during a conversion between a target block of a video and a bitstream of the target block, a multiple hypothesis prediction block of the target block based on a plurality of intra predictions; and performing the conversion based on the multiple hypothesis prediction block.

Clause 34. The method of clause 33, wherein a plurality of hypothesizes of the multiple hypothesis prediction block is intra predicted.

Clause 35. The method of clause 33, wherein the multiple hypothesis prediction block is a multi-hypothesis prediction (MHP) block, and the MHP block comprises a plurality of intra coded hypothesizes.

Clause 36. The method of clause 33, wherein the multiple hypothesis prediction block is a combined inter and intra prediction (CIIP) block, and the CIIP block comprises at least two intra predictions.

Clause 37. The method of clause 33, wherein the multiple hypothesis prediction block is a geometric partitioning mode (GPM) block, and both partitions of the GPM block are intra mode coded.

Clause 38. The method of clause 33, wherein the multiple hypothesis prediction block is a GPM block, and intra modes of two partitions of the GPM block are not allowed to be the same.

Clause 39. The method of clause 33, the multiple hypothesis prediction block is a GPM block, and a first intra mode of a first partition of the GPM block is indicated in the bitstream.

Clause 40. The method of clause 39, wherein a second intra mode of a second partition of the GPM block is implicitly derived.

Clause 41. The method of clause 39, wherein the first intra mode of the first partition is excluded from coded representation of the second partition.

Clause 42. The method of clause 33, wherein the multiple hypothesis prediction block is a GPM block, and intra modes of two partitions of the GPM block are indicated in the bitstream.

Clause 43. The method of clause 33, wherein the multiple hypothesis prediction block is a GPM block, and intra modes of two partitions of the GPM block are implicitly derived.

Clause 44. The method of clause 33, wherein two intra predictions of two partitions are weighted blended.

Clause 45. The method of clause 44, wherein the multiple hypothesis prediction block is a GPM block, and two intra predictions of the GPM block are weighted blended.

Clause 46. The method of clause 44, wherein all samples within in a partition of the two partitions have a same weighting factor.

Clause 47. The method of clause 44, wherein different samples have different weighting factors.

Clause 48. The method of clause 44, wherein a weighting factor depends on a splitting method of the GPM block.

Clause 49. The method of clause 44, wherein a weighting factor depends on at least one intra-prediction mode of the multiple hypothesis prediction block.

Clause 50. The method of clause 33, wherein the multiple hypothesis prediction block is split by at least one oblique partition line, or wherein the multiple hypothesis prediction block is split by at least one straight partition line.

Clause 51. The method of clause 50, wherein a splitting mode of the target block is indicated in the bitstream.

Clause 52. The method of clause 50, wherein a splitting mode of the target block is indicated in a same way as GPM partition mode index.

Clause 53. The method of clause 50, wherein a splitting mode of the target block is implicitly derived based on coding information of the target block.

Clause 54. The method of clause 33, wherein at least one syntax element indicating whether an intra prediction of a GPM partition is derived at the decoder side is indicated.

Clause 55. The method of clause 54, wherein a coding unit (CU) based flag is indicated for the target block.

Clause 56. The method of clause 54, wherein a partition based flag is indicated for a partition the target block.

Clause 57. The method of clause 54, wherein a decoder derived intra prediction comprises a decoder side intra mode derivation or a template-based intra mode derivation.

Clause 58. The method of clause 33, wherein if only L0 reference list is available, the multiple hypothesis prediction block is allowed for P slice or picture, and wherein if both L0 reference list and L1 reference list, the multiple hypothesis prediction block is allowed for B slice or picture.

Clause 59. The method of clause 58, wherein the multiple hypothesis prediction block is a GPM block, the GPM block is allowed for P slice or picture.

Clause 60. The method of clause 58, wherein the multiple hypothesis prediction block is a GPM block, and two partitions of the GPM block comprise an intra prediction and an inter prediction.

Clause 61. The method of clause 60, wherein the inter prediction comprises a L0 prediction or a L1 prediction.

Clause 62. The method of clause 60, wherein the intra prediction is predefined or indicated.

Clause 63. The method of clause 58, wherein the multiple hypothesis prediction block is a GPM block, and two partitions of the GPM block comprise a first intra prediction and a second intra prediction.

Clause 64. The method of clause 63, wherein intra modes of the two partitions are not allowed to be the same.

Clause 65. The method of clause 58, wherein the multiple hypothesis prediction block is a GPM block, and two partitions of the GPM block comprise a first inter prediction and a second inter prediction.

Clause 66. The method of clause 65, wherein the GPM block comprises two L0 predictions, or wherein the GPM block comprises two L1 predictions.

Clause 67. The method of clause 65, wherein motion information of the first inter prediction and the second inter predication is not allowed to be the same.

Clause 68. The method of clause 65, wherein the two partitions are predicted from a same predication direction, and motion vectors of the two partitions are added together or averaged for blended area motion storage.

Clause 69. The method of clause 68, wherein if a prediction direction and a reference index of the two partitions are same, the motion vectors of the two partitions are added together or averaged for motion storage of the blended area.

Clause 70. The method of clause 68, wherein if a prediction direction of the two partitions is same and reference indexes of the two partitions are different, motion storage of the blended area is based on a motion vector scaling process.

Clause 71. The method of clause 58, wherein if two partitions of the multiple hypothesis prediction block are predicted from a same prediction direction, a motion vector of a target partition with a smaller reference among the two partitions index is stored.

Clause 72. The method of clause 58, wherein if two partitions of the multiple hypothesis prediction block are predicted from a same prediction direction, a motion vector of a target partition with a smaller |MVx|+|MVy| is stored, and MVx and MVy represent motion vectors in two directions, repectively.

Clause 73. The method of clause 33, wherein a GPM candidate list is constructed based on regular merge candidates of which have a specific prediction direction.

Clause 74. The method of clause 33, wherein a first GPM candidate list for P slice is constructed in a difference way from a second GPM candidate list for B slice.

Clause 75. The method of clause 74, wherein the first GPM candidate list for P slice is a

subset of the second GPM candidate list for B slice.

Clause 76. The method of clause 33, wherein the multiple hypothesis prediction block is allowed for I slice or picture.

Clause 77. The method of clause 76, wherein the multiple hypothesis prediction block is a GPM block, and the GPM block is allowed for I slice or picture.

Clause 78. The method of clause 77, wherein the GPM block comprises two non-inter predictions.

Clause 79. The method of clause 78, wherein one of the two non-inter prediction comprises one of: an intra prediction, an intra block copy, or a palette prediction.

Clause 80. The method of clause 77, wherein different intra modes are used for two partitions of the GPM block.

Clause 81. The method of clause 77, wherein a sample based weighting factor is sued to blend two partitions of the GPM block.

Clause 82. The method of clause 76, wherein the multiple hypothesis prediction block is a CIIP block, and the CIIP block is allowed for I slice or picture.

Clause 83. The method of clause 82, wherein the CIIP block comprises an intra prediction and a non-inter prediction.

Clause 84. The method of clause 83, wherein the non-inter prediction comprises one of: an intra prediction, an intra block copy, or a palette prediction.

Clause 85. The method of clause 82, wherein different intra modes are used for two predictions of the CIIP block.

Clause 86. The method of clause 82, wherein a block-based weighting factor is used to blend two predictions of the CIIP block.

Clause 87. The method of clause 76, wherein the multiple hypothesis prediction block is a MHP block, and the MHP block is allowed for I slice or picture.

Clause 88. The method of clause 87, wherein the MHP block comprises multiple non-inter predictions.

Clause 89. The method of clause 87, wherein the multiple non-inter prediction comprise one of: an intra prediction, an intra block copy, or a palette prediction.

Clause 90. The method of clause 87, wherein different intra modes are used for multiple hypotheses of the MHP block.

Clause 91. The method of clause 87, wherein a block-based weighting factor is used to blend multiple hypotheses of the MHP block.

Clause 92. The method of clause 33, wherein if IBC is involved in one of: GPM, CIIP or MHP, information for the IBC is indicated.

Clause 93. The method of clause 33, wherein if paltette is involved in one of: GPM, CIIP or MHP, information for the paltette is indicated.

Clause 94. The method of any of clauses 33-93, wherein an indication of whether to and/or how to generate the multiple hypothesis prediction block is indicated at one of the followings: sequence level, group of pictures level, picture level, slice level, or tile group level.

Clause 95. The method of any of clauses 33-93, wherein an indication of whether to and/or how to generate the multiple hypothesis prediction block is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 96. The method of any of clauses 33-93, wherein an indication of whether to and/or how to generate the multiple hypothesis prediction block is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 97. The method of any of clauses 33-93, further comprising: determining, based on coded information of the target block, whether to and/or how to generate the multiple hypothesis prediction block, the coded information including at least one of: a block size, a colour format, a single and/or dual tree partitioning, a colour component, a slice type, or a picture type.

Clause 98. A method of video processing, comprising: determining, during a conversion between a target block of a video and a bitstream of the target block, whether a coding unit (CU) based geometric partitioning mode (GPM) template matching syntax element is indicated based on whether an intra-inter coding is applied to the target block, the target blocking being a GPM block; and performing the conversion based on the determining

Clause 99. The method of clause 98, wherein if the target block is coded by intra-inter prediction, the CU based GPM template matching is not allowed to be further applied.

Clause 100. The method of 99, wherein if the CU based GPM template matching is not allowed for a GPM intra-inter block, a CU level template matching based flag is not indicated by inferring to a certain value.

Clause 101. The method of clause 98, wherein whether the intra-inter coding is allowed for the target block is determined based on whether the CU based GPM template matching is used for the target block.

Clause 102. The method of clause 101, wherein if the CU based GPM template matching is used, the intra-inter prediction is not allowed to be further applied.

Clause 103. The method of clause 101, wherein the intra-inter prediction is not allowed for the target block, intra coded information is not indicated in the bitstream.

Clause 104. The method of clause 98, wherein a GPM intra-inter prediction block is allowed to use a partition-based GPM template matching.

Clause 105. The method of clause 104, wherein if the partition-based GPM template matching is allowed for the GPM intra-inter block, a flag is indicated for inter coded partition specifying whether motion of the inter coded partition is further refined by template matching.

Clause 106. The method of any of clauses 98-105, wherein an indication of whether to and/or how to determine whether a coding unit (CU) based geometric partitioning mode (GPM) template matching syntax element is indicated at one of the followings: sequence level, group of pictures level, picture level, slice level, or tile group level.

Clause 107. The method of any of clauses 98-105, wherein an indication of whether to and/or how to determine whether a coding unit (CU) based geometric partitioning mode (GPM) template matching syntax element is indicated is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 108. The method of any of clauses 98-105, wherein an indication of whether to and/or how to determine whether a coding unit (CU) based geometric partitioning mode (GPM) template matching syntax element is indicated is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 109. The method of any of clauses 98-105, further comprising: determining, based on coded information of the target block, whether to and/or how to determine whether a coding unit (CU) based geometric partitioning mode (GPM) template matching syntax element is indicated, the coded information including at least one of: a block size, a colour format, a single and/or dual tree partitioning, a colour component, a slice type, or a picture type.

Clause 110. A method of video processing, comprising: determining, during a conversion between a target block of a video and a bitstream of the target block, for a coding method, a shape of a template used for the target block based on an availability of a neighboring sample associated with the target block; and performing the conversion based on the determining

Clause 111. The method of clause 110, wherein if above samples are available but left samples are not available, the template comprises the above samples only, or wherein if the left samples are available but the above samples are not available, the template comprises the left samples only, or wherein if the left samples and the above samples are not available, no template is used.

Clause 112. The method of clause 110, wherein a virtual template is used in which at least one sample of the template is generated by a specific mean.

Clause 113. The method of clause 112, wherein padding is utilized to fill in samples which are unavailable.

Clause 114. The method of clause 110, wherein the template is used for one of the followings: a template matching based motion vector (MV), a template matching based block vector (BV) derivation, or a template matching based intra-prediction derivation.

Clause 115. The method of any of clauses 110-114, wherein an indication of whether to and/or how to determine the shape of a template used for the target block is indicated at one of the followings: sequence level, group of pictures level, picture level, slice level, or tile group level.

Clause 116. The method of any of clauses 110-114, wherein an indication of whether to and/or how to determine the shape of a template used for the target block is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 117. The method of any of clauses 110-114, wherein an indication of whether to and/or how to determine the shape of a template used for the target block is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 118. The method of any of clauses 110-114, further comprising: determining, based on coded information of the target block, whether to and/or how to determine the shape of a template used for the target block, the coded information including at least one of: a block size, a colour format, a single and/or dual tree partitioning, a colour component, a slice type, or a picture type.

Clause 119. The method of any one of clauses 1-118, wherein at least one of: a filter coefficient or a clipping value is allowed to be a value not equal to a power of 2.

Clause 120. The method of clause 119, wherein the filter coefficient of a Cross-Component Adaptive Loop Filter (CCALF) is based on a value not equal to a power of 2.

Clause 121. The method of clause 119, wherein the clipping value is not a power of 2.

Clause 122. The method of any one of clauses 1-118, wherein a chroma component and a luma component share a filter shape.

Clause 123. The method of clause 122, wherein a first filter shape for chroma and a second filter shape for luma are the same, a first filter length for chroma and a second filter length for luma are different.

Clause 124. The method of clause 122, where an M×N diamond/cross shape filter is used for the luma component of a loop filter, the chroma component associated with the luma component is allowed to use a diamond/cross shape filter with a size of M×N, wherein M is larger than SubWidthC, N is larger than SubHeightC, and the SubWidthC and the SubHeightC depend on a chroma format sampling structure.

Clause 125. The method of clause 124, wherein the SubWidthC and the SubHeightC equal to 2 for 4:2:0 chroma format.

Clause 126. The method of clause 124, wherein the SubWidthC and the SubHeightC equal to 1 for 4:4:4 chroma format.

Clause 127. The method of clause 124, wherein the SubWidthC equals to 2 and the SubHeightC equal to 1 for 4:2:2 chroma format.

Clause 128. The method of clause 122, wherein if a chroma format is 4:4:4, the chroma component and the luma component share a filter shape.

Clause 129. The method of any of clauses 1-128, wherein the conversion includes encoding the target block into the bitstream.

Clause 130. The method of any of clauses 1-128, wherein the conversion includes decoding the target block from the bitstream.

Clause 131. An apparatus for processing video data comprising a processor and a non-transitory memory with instructions thereon, wherein the instructions upon execution by the processor, cause the processor to perform a method in accordance with any of clauses 1-32, or any of clauses 33-97, or any of clauses 98-109, or any of clauses 110-118, or any of clauses 119-130.

Clause 132. A non-transitory computer-readable storage medium storing instructions that cause a processor to perform a method in accordance with any of clauses 1-32, or any of clauses 33-97, or any of clauses 98-109, or any of clauses 110-118, or any of clauses 119-130.

Clause 133. A non-transitory computer-readable recording medium storing a bitstream of a video which is generated by a method performed by a video processing apparatus, wherein the method comprises: determining storing information about coding information of a first part of a target block, the target block being coded with a geometric partitioning mode (GPM); and generating a bitstream of the target block based on the storing information.

Clause 134. A method for storing bitstream of a video, comprising: determining storing information about coding information of a first part of a target block, the target block being coded with a geometric partitioning mode (GPM); generating a bitstream of the target block based on the storing information; and storing the bitstream in a non-transitory computer-readable recording medium.

Clause 135. A non-transitory computer-readable recording medium storing a bitstream of a video which is generated by a method performed by a video processing apparatus, wherein the method comprises: generating a multiple hypothesis prediction block of a target block based on a plurality of intra predictions; and generating a bitstream of the target block based on the multiple hypothesis prediction block.

Clause 136. A method for storing bitstream of a video, comprising: generating a multiple hypothesis prediction block of a target block based on a plurality of intra predictions; generating a bitstream of the target block based on the multiple hypothesis prediction block; and storing the bitstream in a non-transitory computer-readable recording medium.

Clause 137. A non-transitory computer-readable recording medium storing a bitstream of a video which is generated by a method performed by a video processing apparatus, wherein the method comprises: determining whether a coding unit (CU) based geometric partitioning mode (GPM) template matching syntax element is indicated based on whether an intra-inter coding is applied to a target block, the target blocking being a GPM block; and generating a bitstream of the target block based on the determining

Clause 138. A method for storing bitstream of a video, comprising: determining whether a coding unit (CU) based geometric partitioning mode (GPM) template matching syntax element is indicated based on whether an intra-inter coding is applied to a target block, the target blocking being a GPM block; generating a bitstream of the target block based on the determining; and storing the bitstream in a non-transitory computer-readable recording medium.

Clause 139. A non-transitory computer-readable recording medium storing a bitstream of a video which is generated by a method performed by a video processing apparatus, wherein the method comprises: determining, for a coding method, a shape of a template used for a target block based on an availability of a neighboring sample associated with the target block; and generating a bitstream of the target block based on the determining

Clause 140. A method for storing bitstream of a video, comprising: determining, for a coding method, a shape of a template used for a target block based on an availability of a neighboring sample associated with the target block; generating a bitstream of the target block based on the determining; and storing the bitstream in a non-transitory computer-readable recording medium.

### Example Device

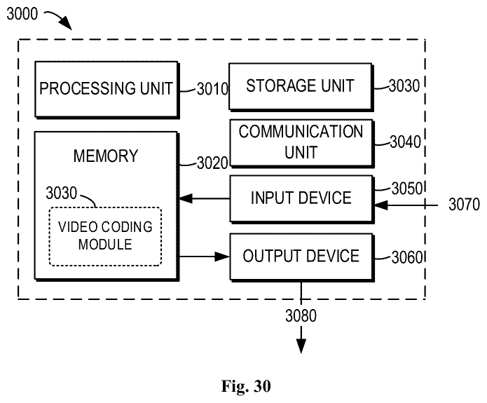

FIG. 30 illustrates a block diagram of a computing device 3000 in which various embodiments of the present disclosure can be implemented. The computing device 3000 may be implemented as or included in the source device 110 (or the video encoder 114 or 200) or the destination device 120 (or the video decoder 124 or 300).

It would be appreciated that the computing device 3000 shown in FIG. 30 is merely for purpose of illustration, without suggesting any limitation to the functions and scopes of the embodiments of the present disclosure in any manner.

As shown in FIG. 30, the computing device 3000 includes a general-purpose computing device 3000. The computing device 3000 may at least comprise one or more processors or processing units 3010, a memory 3020, a storage unit 3030, one or more communication units 3040, one or more input devices 3050, and one or more output devices 3060.

In some embodiments, the computing device 3000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3000 can support any type of interface to a user (such as “wearable” circuitry and the like).

The processing unit 3010 may be a physical or virtual processor and can implement various processes based on programs stored in the memory 3020. In a multi-processor system, multiple processing units execute computer executable instructions in parallel so as to improve the parallel processing capability of the computing device 3000. The processing unit 3010 may also be referred to as a central processing unit (CPU), a microprocessor, a controller or a microcontroller.

The computing device 3000 typically includes various computer storage medium. Such medium can be any medium accessible by the computing device 3000, including, but not limited to, volatile and non-volatile medium, or detachable and non-detachable medium. The memory 3020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3030 may be any detachable or non-detachable medium and may include a machine-readable medium such as a memory, flash memory drive, magnetic disk or another other media, which can be used for storing information and/or data and can be accessed in the computing device 3000.

The computing device 3000 may further include additional detachable/non-detachable, volatile/non-volatile memory medium. Although not shown in FIG. 30, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3040 communicates with a further computing device via the communication medium. In addition, the functions of the components in the computing device 3000 can be implemented by a single computing cluster or multiple computing machines that can communicate via communication connections. Therefore, the computing device 3000 can operate in a networked environment using a logical connection with one or more other servers, networked personal computers (PCs) or further general network nodes.

The input device 3050 may be one or more of a variety of input devices, such as a mouse, keyboard, tracking ball, voice-input device, and the like. The output device 3060 may be one or more of a variety of output devices, such as a display, loudspeaker, printer, and the like. By means of the communication unit 3040, the computing device 3000 can further communicate with one or more external devices (not shown) such as the storage devices and display device, with one or more devices enabling the user to interact with the computing device 3000, or any devices (such as a network card, a modem and the like) enabling the computing device 3000 to communicate with one or more other computing devices, if required. Such communication can be performed via input/output (I/O) interfaces (not shown).

In some embodiments, instead of being integrated in a single device, some or all components of the computing device 3000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3000 may be used to implement video encoding/decoding in embodiments of the present disclosure. The memory 3020 may include one or more video coding modules 3025 having one or more program instructions. These modules are accessible and executable by the processing unit 3010 to perform the functionalities of the various embodiments described herein.

In the example embodiments of performing video encoding, the input device 3050 may receive video data as an input 3070 to be encoded. The video data may be processed, for example, by the video coding module 3025, to generate an encoded bitstream. The encoded bitstream may be provided via the output device 3060 as an output 3080.

In the example embodiments of performing video decoding, the input device 3050 may receive an encoded bitstream as the input 3070. The encoded bitstream may be processed, for example, by the video coding module 3025, to generate decoded video data. The decoded video data may be provided via the output device 3060 as the output 3080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a target block of a video and a bitstream of the target block, storing information about coding information of a first part of the target block, the target block being coded with a geometric partitioning mode (GPM); and
performing the conversion based on the storing information.

2. The method of claim 1, wherein the target block is a GPM intra-intra prediction block, or the target block is a GPM intra-inter prediction block, and the first part of the target block is an intra coded partition of the target block, or
wherein the coding information is stored on a M×N basis, and wherein M and N represent numbers of samples, respectively, or
wherein the coding information of the first part of the target block is stored based on a zero motion vector, or
wherein the coding information of the first part of the target block is stored based on a reference index equal to −1, or
wherein the coding information of the first part of the target block is stored based on a reference index which equals to a reference index of a current slice or a current picture associated with the target block, or
wherein the coding information of the first part of the target block is stored based on a default inter motion, or
wherein the coding information of the first part of the target block is stored based on a default intra mode, or
wherein whether to store intra coded information of the target block or inter coded information of the target block is determined based on partition information of the target block, or
wherein the coding information is used by succeeding coded blocks or succeeding decode block, or wherein the coding information is used for a deblocking process, or
wherein the storing information indicates at least one of:
how to store the coding information of the first part of the target block, or
whether to store the coding information of the first part of the target block, or
wherein an indication of whether to and/or how to determine how to store the coding information is indicated at one of the followings:
sequence level,
group of pictures level,
picture level,
slice level, or
tile group level, or
wherein an indication of whether to and/or how to determine how to store the coding information is indicated in one of the following:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header, or
wherein an indication of whether to and/or how to determine how to store the coding information is included in one of the following:
a prediction block (PB),
a transform block (TB),
a coding block (CB),
a prediction unit (PU),
a transform unit (TU),
a coding unit (CU),
a virtual pipeline data unit (VPDU),
a coding tree unit (CTU),
a CTU row,
a slice,
a tile,
a sub-picture, or
a region containing more than one sample or pixel, or
wherein the method further comprises:
determining, based on coded information of the target block, whether to and/or how to determine how to store the coding information, the coded information including at least one of:
a block size,
a colour format,
a single and/or dual tree partitioning,
a colour component,
a slice type, or
a picture type, or
wherein the conversion includes encoding the target block into the bitstream, or
wherein the conversion includes decoding the target block from the bitstream.

3. The method of claim 1, wherein the coding information of the first part of the target block is stored based on at least one of the followings:
a real intra prediction mode used to derive an intra prediction of the target block,
an angle used to derive the intra prediction of the target block, or
a direction used to derive the intra prediction of the target block.

4. The method of claim 3, wherein at least one of the following does not belong to one of a regular intra mode index:
the real intra prediction mode,
the angle, or
the direction, or
wherein at least one of the followings is mapped to one of a regular intra mode index for storing coding information:
the real intra prediction mode,
the angle, or
the direction, or
wherein at least one of the followings is not stored:
the real intra prediction mode,
the angle, or
the direction.

5. The method of claim 1, wherein at a blending area of the target block, whether to store intra coded information of the target block or inter coded information of the target block is predefined.

6. The method of claim 5, wherein the blending area comprise an intra-inter fusion area that is along a GPM partition line, or
wherein if a sample belongs to the blending area, a plurality of weighting values used in GPM for the sample are not equal to 0, or
wherein the intra coded information of the target block is stored by default, or
wherein the inter coded information of the target block is stored by default.

7. The method of claim 1, wherein at a blending area of the target block, coded information of which partition is stored is predefined.

8. The method of claim 7, wherein if a sample belong to the blending area, a plurality of weighting values used in GPM for the sample are not equal to 0, or
wherein whether to store the coded information of the first part or coded information of a second part is determined based on partition information of the target block, or
wherein whether to store the coded information of the first part or coded information of a second part is determined based on two intra-prediction modes.

9. A method of video processing, comprising:
generating, during a conversion between a target block of a video and a bitstream of the target block, a multiple hypothesis prediction block of the target block based on a plurality of intra predictions; and
performing the conversion based on the multiple hypothesis prediction block.

10. The method of claim 9, wherein a plurality of hypothesizes of the multiple hypothesis prediction block is intra predicted, or
wherein the multiple hypothesis prediction block is a multi-hypothesis prediction (MHP) block, and the MHP block comprises a plurality of intra coded hypothesizes, or
wherein the multiple hypothesis prediction block is a combined inter and intra prediction (CIIP) block, and the CIIP block comprises at least two intra predictions, or
wherein the multiple hypothesis prediction block is a geometric partitioning mode (GPM) block, and both partitions of the GPM block are intra mode coded, or
wherein the multiple hypothesis prediction block is a GPM block, and intra modes of two partitions of the GPM block are not allowed to be the same, or
wherein the multiple hypothesis prediction block is a GPM block, and a first intra mode of a first partition of the GPM block is indicated in the bitstream, or
wherein the multiple hypothesis prediction block is a GPM block, and intra modes of two partitions of the GPM block are indicated in the bitstream, or
wherein the multiple hypothesis prediction block is a GPM block, and intra modes of two partitions of the GPM block are implicitly derived, or
wherein the multiple hypothesis prediction block is split by at least one oblique partition line, or wherein the multiple hypothesis prediction block is split by at least one straight partition line, or
wherein at least one syntax element indicating whether an intra prediction of a GPM partition is derived at the decoder side is indicated, or
wherein if only L0 reference list is available, the multiple hypothesis prediction block is allowed for P slice or picture, and wherein if both L0 reference list and L1 reference list, the multiple hypothesis prediction block is allowed for B slice or picture, or
wherein a GPM candidate list is constructed based on regular merge candidates of which have a specific prediction direction, or
wherein a first GPM candidate list for P slice is constructed in a difference way from a second GPM candidate list for B slice, or
wherein if IBC is involved in one of: GPM, CIIP or MHP, information for the IBC is indicated, or
wherein if palette is involved in one of: GPM, CIIP or MHP, information for the palette is indicated, or
wherein an indication of whether to and/or how to generate the multiple hypothesis prediction block is indicated at one of the followings:
sequence level,
group of pictures level,
picture level,
slice level, or
tile group level, or
wherein an indication of whether to and/or how to generate the multiple hypothesis prediction block is indicated in one of the following:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header, or
wherein an indication of whether to and/or how to generate the multiple hypothesis prediction block is included in one of the following:
a prediction block (PB),
a transform block (TB),
a coding block (CB),
a prediction unit (PU),
a transform unit (TU),
a coding unit (CU),
a virtual pipeline data unit (VPDU),
a coding tree unit (CTU),
a CTU row,
a slice,
a tile,
a sub-picture, or
a region containing more than one sample or pixel, or
wherein the method further comprises:
determining, based on coded information of the target block, whether to and/or how to generate the multiple hypothesis prediction block, the coded information including at least one of:
a block size,
a colour format,
a single and/or dual tree partitioning,
a colour component,
a slice type, or
a picture type, or
wherein the conversion includes encoding the target block into the bitstream, or wherein the conversion includes decoding the target block from the bitstream.

11. The method of claim 9, wherein two intra predictions of two partitions are weighted blended.

12. The method of claim 11, wherein the multiple hypothesis prediction block is a GPM block, and two intra predictions of the GPM block are weighted blended, or
wherein all samples within in a partition of the two partitions have a same weighting factor, or
wherein different samples have different weighting factors, or
wherein a weighting factor depends on a splitting method of the GPM block, or
wherein a weighting factor depends on at least one intra-prediction mode of the multiple hypothesis prediction block.

13. The method of claim 9, wherein the multiple hypothesis prediction block is allowed for I slice or picture.

14. The method of claim 13, wherein the multiple hypothesis prediction block is a GPM block, and the GPM block is allowed for I slice or picture.

15. The method of claim 14, wherein the GPM block comprises two non-inter predictions, or
wherein different intra modes are used for two partitions of the GPM block, or
wherein a sample based weighting factor is sued to blend two partitions of the GPM block.

16. The method of claim 13, wherein the multiple hypothesis prediction block is a CIIP block, and the CIIP block is allowed for I slice or picture.

17. The method of claim 16, wherein the CIIP block comprises an intra prediction and a non-inter prediction, or
wherein different intra modes are used for two predictions of the CIIP block, or
wherein a block-based weighting factor is used to blend two predictions of the CIIP block.

18. The method of claim 13, wherein the multiple hypothesis prediction block is a MHP block, and the MHP block is allowed for I slice or picture.

19. The method of claim 18, wherein the MHP block comprises multiple non-inter predictions, or
wherein the multiple non-inter prediction comprise one of:
an intra prediction,
an intra block copy, or
a palette prediction, or
wherein different intra modes are used for multiple hypotheses of the MHP block, or
wherein a block-based weighting factor is used to blend multiple hypotheses of the MHP block.

20. A method of video processing, comprising:
determining, during a conversion between a target block of a video and a bitstream of the target block, at least one of the followings:
whether a coding unit (CU) based geometric partitioning mode (GPM) template matching syntax element is indicated based on whether an intra-inter coding is applied to the target block, the target blocking being a GPM block, or
for a coding method, a shape of a template used for the target block based on an availability of a neighboring sample associated with the target block; and
performing the conversion based on the determining.
